(19) United States
(12) Patent Application Publication
(10) Pub. No.: US 2008/0285886 A1
(43) Pub. Date: Nov. 20, 2008

(54) System For Displaying Images

(76) Inventor: Matthew Emmerson Allen, West Sussex (GB)

Correspondence Address: Matthew E. Allen, The Lodge, 2 Ford Road, Arundel, BN18 9EA, omitted

(21) Appl. No.: 11/909,693

(22) PCT Filed: Mar. 29, 2006
(86) PCT No.: PCT/GB2006/001159

§ 371 Date: Jun. 13, 2008

(30) Foreign Application Priority Data
Mar. 29, 2005 (GB) 0506280.1
May 16, 2005 (GB) 0509832.2
May 27, 2005 (GB) 0510927.7
Jun. 9, 2005 (GB) 0511676.9
Jul. 21, 2005 (GB) 0514995.0
Aug. 16, 2005 (GB) 0516719.2

(51) Int. Cl. G06T 11/00

(52) U.S. Cl. 382/284

(57) ABSTRACT

The invention relates to an electronic image storage and display system. The system comprises a storage means for storing a plurality of images. The plurality of images are taken, at a location between two sides of a road, on a pavement or the like at a side of a road, or between buildings at two sides of a road, at adjacent locations along the sides of the roads, so that they cover the total extent of a plurality of roads. The system comprises a location selection interface, e.g. a map interface 12 or drop down menus, arranged to allow a user to select a location and the system is arranged to receive and process selection, and retrieve an image of a selected location from storage means. The system can sequence a plurality of images of a selected path and play the path back in order. The system also comprises a map 18 which can display the selected location markers as a series of images, e.g. relating to a path, are displayed. The system may be internet based. In another embodiment, the system can be used with in-car satellite navigation equipment.

The present invention relates to a system for displaying an image of a particular location, an image display system which displays an image of a particular location, a method of retrieving an image of a location, a system for obtaining and storing an image of various locations, and a method of obtaining an image or images of a location.

It is known to type a location in a field of an internet webpage and receive a further webpage including an aerial photo corresponding to the location. In the known system, marketed by Getmapping™, the photo is taken in an approximately vertically downwardly direction, i.e. perpendicular to the plane of the ground, from an air-based object such as a satellite. It is possible to zoom in and out to see greater detail and to cover a larger area respectively.

In the known aerial photo system only the “top” of objects can be seen. As such, the known aerial photo system, whilst useful, provides only limited information.

It is an aim of the invention to provide a different location image display system.

According to a first aspect of the invention there is provided an electronic image storage and display system according to claim 1.

According to a second aspect of the invention there is provided an electronic image storage and display system, the system comprising a storage means for storing a plurality of images, wherein the storage means comprises at least two images of adjacent locations at a side of a road, the images being taken of adjacent locations along the side of a road, the system comprises a location selection interface arranged to allow a user to select a location, and the system is arranged to receive and process selection, and retrieve an image of a selected location for display to a user.

According to a third aspect of the invention there is provided an electronic image storage and display system, the system comprising a storage means for storing a plurality of images, wherein the storage means comprises at least two images of adjacent locations at a side of a road, the images being taken at adjacent locations along the side of a road, the system comprises a location selection interface arranged to allow a user to select a location, and the system is arranged to receive and process selection, and retrieve an image of a selected location for display to a user.

According to a fourth aspect of the invention there is provided an electronic image storage and display system, the system comprising a storage means for storing a plurality of images, the system also comprising an interface arranged to allow a user to select a location, a location selection interface for a user to select a location, and the system is arranged to receive and process selection, and retrieve an image of a selected location for display to a user, wherein storage means comprises an image of a location taken at a location between two sides of a road, on a pavement or the like at a side of a road, or between buildings at two sides of a road.

According to a fifth aspect of the invention there is provided an electronic image storage and display system for storing and displaying images of locations according to Claim 2.

According to a sixth aspect of the invention there is provided an electronic image storage and display system for storing and displaying images of locations, the system comprising a storage means, the storage means comprising a plurality of still or moving images of locations, wherein storage means comprises images taken in a direction roughly parallel to the plane of the ground, the system comprises a location selection interface arranged to allow a user to select a location, and the system is arranged to receive and process selection, and retrieve an image of a selected location for display to a user.

According to a seventh aspect of the invention there is provided an electronic image storage system for storing and displaying images of locations, the system comprising a storage means, the storage means comprising a plurality of still or moving images of locations, wherein each image of a location is taken at a location between two sides of a road, or between buildings at two sides of a road, and in a direction transverse to the lengthwise direction of a road so as to show at least part of a side of a road, the system comprises a location selection interface arranged to allow a user of the system to select a location, and the system is arranged to receive and process selection, and retrieve an image of a selected location for display to a user.

Preferably, the storage means comprises an image or images of all of at least one side of a road. Preferably, the storage means comprises an image or images of at least part of both sides of a road.

According to an eighth aspect of the invention there is provided an electronic image storage system for storing and displaying images of locations, the system comprising a storage means, the storage means comprising a plurality of still or moving images of locations including at least part of both sides of a road, the system comprises a location selection means arranged to allow a user of the system to input a location so as to view an image of the location.

Preferably, the storage means comprises a first image showing at least part of a first side of a road, and a second image showing at least part of a second side of a road. Preferably, the storage means comprises a first image which shows only a first side of a road, and a second image which shows only a second side of a road. Preferably, the storage means comprises images of the total length of a first side of a road and part of a second side of the road. Preferably, the storage means comprises images of the total length of both sides of a road.

According to a ninth aspect of the invention there is provided an electronic image storage system for storing and displaying images of locations, the system comprising a storage means, wherein the storage means comprises images of the total length of both sides of a road, the system comprises a location selection means arranged to allow a user of the system to input a location so as to view an image of the location.

Preferably, the storage means comprises images taken at or adjacent a plurality of roads of part of at least one side of a plurality of roads.

According to a tenth aspect of the invention there is provided an electronic image storage and display system, the system comprising a storage means for storing a plurality of images, wherein the storage means comprises images, taken at or adjacent a plurality of roads, of part of at least one side of a plurality of roads, the system comprises a location selection interface arranged to allow a user to select a location, and the system is arranged to receive and process selection, and retrieve an image of a selected location from storage means.

Preferably, the storage means comprises images of all of at least one side of a plurality of roads.

According to an eleventh aspect of the invention there is provided an electronic image storage and display system, the system comprising a storage means for storing a plurality of images, wherein the storage means comprises images of all of at least one side of a plurality of roads, the system comprises a location selection interface arranged to allow a user to select a location, and the system is arranged to receive and process selection, and retrieve an image of a selected location from storage means.

Preferably, the storage means comprises images showing at least part of both sides of a plurality of roads.

According to a twelfth aspect of the invention there is provided an electronic image storage and display system, the system comprising a storage means for storing a plurality of images, wherein the storage means comprises images showing at least part of both sides of a plurality of roads, the system comprises a location selection interface arranged to allow a user to select a location, and the system is arranged to receive and process selection, and retrieve an image of a selected location from storage means.

Preferably, the storage means comprises a first image showing at least part of a first side of a first road, and a second image showing at least part of a second side of a first road, a third image showing at least part of a first side of a second road, and a fourth image showing at least part of a second side of a second road (etcetera). Preferably, the storage means comprises a first image which shows only a first side of a road, and a second image which shows only a second side of a road, a third image showing at least part of a first side of a second road, and a fourth image showing at least part of a second side of a second road (etcetera). Preferably, the storage means comprises images of the total length of a first side of a road, and part of a second side of the road, and part of a first side of a second road, and part of a second side of a second road. Preferably, the storage means comprises images of the total length of a first side of a road, and part of a second side of the road, and total length of a first side of a second road, and part of a second side of a second road. Preferably, the storage means comprises images of the total length of a first side of a road, and total length of a second side of the road, and total length of a first side of a second road, and total length of a second side of a second road.

According to a thirteenth aspect of the invention there is provided an electronic image storage and display system, the system comprising a storage means for storing a plurality of images, wherein the storage means comprises images of the total length of a first side of a road, and total length of a second side of the road, and total length of a first side of a second road, and total length of a second side of a second road, and the system is arranged to receive and process selection, and retrieve an image of a selected location from storage means.

Preferably, the storage means comprises separate images showing each side of each road. Preferably, the storage means comprises images covering total length of both sides of roads. Preferably, the storage means comprises images taken at or adjacent at least ten different named roads. Preferably, the storage means comprises images taken at or adjacent at least fifty different named roads. Preferably, a plurality, preferably the majority, most preferably all, of images in the storage means span up to, but no more than, the full extent of a road. Preferably, the storage means comprises a plurality of images taken at intervals in excess of 0.5 m or so that each of a plurality of images spans at least 0.5 m. Preferably, the storage means comprises a plurality of images taken at intervals of less than every 200 m or so that each of a plurality of images spans less than 200 m. Preferably, the storage means comprises a plurality of images taken at intervals of between 1 m and 200 m or so that each of a plurality of images spans at least 0.5 m and less than 200 m. Preferably, the storage means comprises a plurality of images taken at intervals of between 10-100 m or so that each of a plurality of images spans at least 10 m and less than 100 m. Preferably, the storage means comprises a plurality of images taken at intervals of between 20-50 m or so that each of a plurality of images spans at least 20 m and less than 50 m.

According to a fourteenth aspect of the invention there is provided an electronic image storage and display system, the system comprising a storage means for storing a plurality of images, wherein the storage means comprises a plurality of images taken at intervals of between 20-50 m or so that each of a plurality of images spans at least 20 m and less than 50 m, and the system is arranged to receive and process selection, and retrieve an image of a selected location from storage means.

Preferably, the storage means comprises a plurality of images taken at regular intervals or so that they cover equal distances.

According to a fifteenth aspect of the invention there is provided an electronic image storage and display system, the system comprising a storage means for storing a plurality of images, wherein the storage means comprises a plurality of images taken at regular intervals or so that they cover equal distances, and the system is arranged to receive and process selection, and retrieve an image of a selected location from storage means.

Preferably, the storage means comprises a plurality of images taken at successive locations along a road and which, can be viewed, either individually, as a plurality or as a whole, to provide a panorama of a side of a road. Preferably, the storage means comprises a plurality of images forming a panorama of both sides of a road.

According to a sixteenth aspect of the invention there is provided an electronic image storage and display system, the system comprising a storage means for storing a plurality of images, wherein the storage means comprises a plurality of images forming a panorama of both sides of a road, and the system is arranged to receive and process selection, and retrieve an image of a selected location from storage means.

Preferably, the storage means comprises images forming a panorama of a side of plurality of roads.

According to a seventeenth aspect of the invention there is provided an electronic image storage and display system, the system comprising a storage means for storing a plurality of images, wherein the storage means comprises images forming a panorama of a side of plurality of roads, and the system is arranged to receive and process selection, and retrieve an image of a selected location from storage means.

Preferably, the storage means comprises images forming a panorama of both sides of a plurality of roads.

According to an eighteenth aspect of the invention there is provided an electronic image storage and display system, the system comprising a storage means for storing a plurality of images, wherein the storage means comprises images forming a panorama of both sides of a plurality of roads, and the system is arranged to receive and process selection, and retrieve an image of a selected location from storage means.

Preferably, the storage means comprises a plurality of images for which there are no gaps between images.

According to an nineteenth aspect of the invention there is provided an electronic image storage and display system, the system comprising a storage means for storing a plurality of images, wherein storage means comprises a plurality of images for which there are no gaps between images, and the system is arranged to receive and process selection, and retrieve an image of a selected location from storage means.

Preferably, the storage means comprises a plurality of images which have less than 20% overlap, by content of image, with any image covering an adjacent view.

According to an twentieth aspect of the invention there is provided an electronic image storage and display system, the system comprising a storage means for storing a plurality of images, wherein storage means comprises a plurality of images which have less than 20% overlap, by content of image, with any image covering an adjacent view, and the system is arranged to receive and process selection, and retrieve an image of a selected location from storage means.

Preferably, the storage means comprises a plurality of images which have negligible or no overlap, by content of image, with any image covering an adjacent view.

According to a twenty first aspect of the invention there is provided an electronic image storage and display system, the system comprising a storage means for storing a plurality of images, wherein storage means comprises a plurality of images which have negligible or no overlap, by content of image, with any image covering an adjacent view, and the system is arranged to receive and process selection, and retrieve an image of a selected location from storage means.

According to a twenty second aspect of the invention there is provided an electronic image storage system for storing and displaying images of locations, the system comprising a storage means, wherein the storage means comprises images of the total length of both sides of a plurality of roads, images giving effect of panoramas of both sides of the plurality of roads, and the system comprises a location selection means arranged to allow a user of the system to input a location so as to view an image of a location.

Preferably, the storage means comprises images covering a road length of at least 0.5 km. Preferably, the storage means comprises images covering a road length of at least 1 km. Preferably, wherein the storage means comprises images covering a road length of at least 10 km. Preferably, the storage means comprises images covering a road length of at least 100 km. Preferably, the storage means comprises at least one image, preferably a plurality of images, of every public road, connected to two or more other roads, in a 0.25 km² urban area.

According to a twenty third aspect of the invention there is provided an electronic image storage and display system, the system comprising a storage means for storing a plurality of images, wherein the storage means comprises at least one image, preferably a plurality of images, of every public road, connected to two or more other roads, in a 0.25 km² urban area, and the system is arranged to receive and process selection, and retrieve an image of a selected location from storage means.

Preferably, the storage means is arranged to store at least one image, preferably a plurality of images, of all public roads in the urban area. Preferably, the urban area is at least 0.5 km². Preferably, the urban area is at least 1 km². Preferably, the urban area is at least 5 km². Preferably, the urban area is at least 10 km². Preferably, at least one of the images in the storage means is taken from a (movable) ground based object.

According to a twenty fourth aspect of the invention there is provided an electronic image storage and display system, the system comprising a storage means for storing a plurality of images, wherein at least one of the images in the storage means is taken from a (movable) ground based object, and the system is arranged to receive and process selection, and retrieve an image of a selected location from storage means.

Preferably, at least one image of each of a plurality of roads in the storage means is taken from ground based object. Preferably, each image in the storage means is taken from a ground based object.

According to a twenty fifth aspect of the invention there is provided an electronic image storage system comprising a storage means, the storage means comprising a plurality of still or moving images of at least part of both sides of at least two roads, the images being taken from a ground based object.

Preferably, storage means comprises a plurality of images taken at an angle along axis of the road, i.e. in the direction of the road. Preferably, storage means comprises a plurality of images taken at an angle perpendicular to the direction of the road. Preferably, storage means comprises a plurality of images taken at an angle between the axis of the road and an angle perpendicular to axis of road. Preferably, storage means comprises a plurality of images taken at an angle of between 85 degrees above the plane of the ground and 85 degrees below the plane of the ground. Preferably, storage means comprises a plurality of images taken at an angle between forty five above the plane and the horizontal plane. Preferably, at least one of the images in the storage means is images taken in a direction roughly parallel to the ground.

According to a twenty sixth aspect of the invention there is provided an electronic image storage system comprising a storage means, the storage means comprising a plurality of still or moving images of at least part of both sides of at least two roads, the images taken in a direction roughly parallel to the ground.

Preferably, the storage means comprises images showing an end to end panorama corresponding to the total length of a loop of road. Preferably, the electronic image storage system comprises a second (separate) storage means which is arranged to store a plurality of locations, e.g. successive points, sections along the length of a road, or roads, corresponding to locations at which images stored in storage means were taken. Preferably, images are numbered. Preferably, storage means comprises images of end to end sections of a road loop. Preferably, end to end sections of road loop are numbered in a sequence. Preferably, images of sections of road loop comprise images of a plurality of different named roads. Preferably, the system is arranged to store the dates on which images of at least one road were obtained. Preferably, the system comprises images of plurality of roads and is arranged to store the dates on which images of all roads were obtained. Preferably, the system comprises means for reviewing age of images in storage means. Preferably, system comprises alert means arranged to alert if age of an image exceeds a predetermined threshold, preferably location of aged images given, most preferably via a map. Preferably, the system comprises notification means for notifying that the system has more than a preset no. of images for a particular location. Preferably, the display system comprising a location selection means for allowing a user to select and input a location, and means for receiving a signal relating to the selected location, selection processing means, arranged to process the signal(s) relating to the selected location and an image display means arranged to display an image corresponding to the selected location. Preferably, the image display means comprises a video display means which displays a video corresponding to the selected location. Preferably, the image display means comprises a photo display means which displays a photo corresponding to the selected location. Preferably, the location selection means is arranged to allow a user to select and input a plurality of locations, and means for receiving a signal relating to the selected locations, selection processing means arranged to process the signal(s) relating to the selected locations and an image display means which is arranged to display an image corresponding to each of the selected plurality of locations. Preferably, the image display means comprises a video display means which is arranged to display a video corresponding to the selected locations. Preferably, the image display means comprises a photo display means which is arranged to display a photo corresponding to the selected locations. Preferably, wherein the system is arranged to display the date on which one or a plurality of images are obtained to the user. Preferably, storage means comprises one or more images taken from a pavement or the like adjacent the road, or the road itself. Preferably, storage means comprises one or more images of a side of a road taken from a pavement on an opposite side of a road to the object of the image. Preferably, the location selection means comprises a data field arranged to receive a user entered keyword such as all or part of a street name to obtain an image of that location, or a list of results from which one location can be selected and viewed. Preferably, location selection means comprises a dropdown menu so that a user can select the name of a street they want to view. Preferably, location selection means comprises a dropdown menu so that a user can select the number of an address on the street. Preferably, location selection means comprises dropdown menu so that a user can select the name of an urban area such as a city, town or the like. Preferably, the location selection means comprises dropdown menu so that a user can select the name of a country. Preferably, location selection means comprises, GPS™ field (and/or a field for Galileo™ measurements) and means for reading GPS so as to provide view of correct location.

According to a twenty seventh aspect of the invention there is provided an electronic image storage system according to any preceding claim, wherein the system is arranged so that a user can use dropdown menus to select the name of a country, and a menu drops down from which a country is selected, then a menu of country specific cities/towns drops down and a user can click on one city/town to select it then a menu of city/town specific streets drops down and a user can click on one street to select it, then a menu of street specific property numbers drops down and a user can click on one property number to select it.

Preferably, the location selection means comprises map means. Preferably, the location selection means comprises map interface means. Preferably, the map interface means comprises one selectable location thereon which allows a user to select one location on the map interface means. Preferably, the selectable location is a road, section of a road, or point along a road, or like pathway or other route way such as a waterway, or a building adjacent a road. Preferably, the map interface means comprises a plurality of selectable locations thereon, which allows a user to select one of a plurality of locations on the map interface means. Preferably, the map interface means comprises individually selectable roads, or like pathways, or other route ways such as a waterways, or buildings adjacent a road. Preferably, an image display means is arranged to display one or more images corresponding to the selected road or roads. Preferably, the image display means is arranged to display an image such as a video corresponding to at least part of the selected road or roads. Preferably, the image display means is arranged to display an image such as a video corresponding to the total length of the selected road or roads. Preferably, the image display means is arranged to display an image such as a video showing both sides of the selected road or roads. Preferably, the plurality of selectable locations comprises a plurality of spaced points on or adjacent at least one of the roads on the map interface means. Preferably, the map interface means comprises spaced points on or adjacent all of the roads on the map interface that are connected to at least two other roads. Preferably, the map interface means comprises spaced points on or adjacent all of the roads. Preferably, the spaced points are spaced roughly equally along the or each road. Preferably, the map interface means comprises two spaced apart locations, defining a selectable section spanning two spaced locations, and a means for allowing a user to select the section, preferably further spaced apart locations defining further selectable section or sections. Preferably, the map interface means comprises at least one road divided into a plurality of selectable lengthwise sections. Preferably, map interface means comprises a plurality of selectable lengthwise sections extending consecutively along part of road length, preferably each selectable lengthwise section extending consecutively along part of road length. Preferably, all of the roads on the map interface means that are connected to at least two other roads comprise a selectable lengthwise sections, preferably each extending along part of road length. Preferably, the majority, preferably all, of the public roads on the map interface means comprise a plurality of selectable lengthwise sections, each extending along part of road length. Preferably, plurality of selectable lengthwise sections are of regular length. Preferably, plurality of the selectable lengthwise sections are arranged end to end. Preferably, plurality of lengthwise sections run from road junction to road junction. Preferably, at least one selectable lengthwise section is defined by two breaks in a boundary of a road. Preferably, one or more roads of map interface means comprises at least one selectable lengthwise section in at least one side of a road. Preferably, map interface means comprises at least one selectable lengthwise section in each side boundary of a road. Preferably, map interface means comprises further breaks defining further selectable lengthwise sections on both sides of a plurality of roads. Preferably, map interface means comprises at least one selectable lengthwise section in each road. Preferably, breaks are minimal thereby not excessively disrupting map border continuity. Preferably, selectable sections can change colour/shade/shape when selected, or when a computer mouse hovers over it. Preferably, at least two of the selectable sections are grouped in a pair, e.g. corresponding to opposite sides of a road. Preferably, selectable section has arrow headed end or the like. Preferably, at least one, preferably a plurality of selectable sections, links to an image of the selectable section, preferably taken in the direction of the side of the road. Preferably, selectable points or sections comprise a polygon such as a triangle, rectangle or circle to denote it. Preferably, image display means is arranged to display an image or images relating to entire extent of one or more lengthwise section. Preferably, image display means is arranged to display a single image which shows entire extent of lengthwise section. Preferably, the location selection means comprises selectable locations at a frequency of more than every 0.5 m or selectable sections covering lengths of a road of more than 0.5 m. Preferably, location selection means has selectable locations at a frequency of less than every 200 m or selectable sections covering lengths of a road of less than 200 m. Preferably, location selection means has selectable locations at a frequency of between 1 m and 200 m or selectable sections covering lengths of a road of between 1 m and 200 m. Preferably, location selection means has selectable locations at a frequency of between 10-50 m or selectable sections covering lengths of a road of between 10 m and 50 m. Preferably, the map interface means is arranged so that at least one road, e.g. a road of great popularity or importance such as 5^{th} Avenue in New York or Oxford Street in London, is provided with two or more sets of selectable locations, sections, or paths, along its length. Preferably, the first set of selectable locations is arranged to cover a greater number of selectable locations along its length to the second set. Preferably, the first set offers more detailed images than the second set. Preferably, the first set is arranged to process views in a different direction, e.g. north facing, to the second set, e.g. south facing. Preferably, the map interface means has numbering means for numbering in sequence selected sections or points, and sequencing means ensure images are played in same sequence. Preferably, the map interface has roads that are broken down into cells or points or selectable sections, and map interface has cells or points that can be selected by hovering mouse there over and clicking to select a cell or point, and image display means is arranged to an image corresponding to the cell or point. Preferably, map interface comprises selectable selections covering entire length of a road. Preferably, map interface comprises selectable selections covering both sides of a road. Preferably, system comprises means for entering an address (e.g. on website) and image display means arranged to display images and map of location. Preferably, system comprises means for entering plurality of addresses, and image display means arranged to display plurality of images and map(s) showing locations. Preferably, system arranged so that a user can simply click on a map, or sequence of maps, in order to get the map interface in the first place, zooming in appropriately. Preferably, one can start on a world map, optionally select a country, select a city, optionally select a sub city view, select a street, and optionally select a street number.

Preferably, system arranged to inform of locations on map interface that require an image, e.g. because there is no image or because existing image is out of date, for example by applying a different colour, line thickness or other suitable indicia, applied to cell, section or point. Preferably, system has reception means arranged to be able to receive an image of a location from a remote user. Preferably, the map interface means comprises a three dimensional map. Preferably, shapes of buildings such as shops on a road can be simply and schematically rendered. Preferably, the shops are labeled with their name. Preferably, the user can select a building by clicking on (the fronts or tops of) them to either look through shop window or to “go in” the shop and look around the interior of the shop. Preferably, system is arranged to electronically receive images of shop fronts or shop interiors from shop owners or authorized persons. Preferably, system is arranged to display a plurality of images, in the way of a slideshow of successive individual photos. Preferably, system is arranged to display a plurality of images, in the way of multiple slideshows of individual photos, each slideshow showing photos taken in different directions. Preferably, system is arranged to display a plurality of images, in the way of a slideshow, and plurality of photos can be simultaneously displayed, e.g. consecutively one after the other, e.g. to provide a gapless panorama. Preferably, system comprises a map with address book data such as street numbers overlaying it, to assist user. Preferably, location selection means comprises a path/route selection means allowing a user to choose at least two spaced locations and the image display means is arranged to display images of path/route. Preferably, the location selection means comprises a map interface means, and path selection means allows a user to select a path between two locations and image display means is arranged to display images corresponding to at least part of the selected path. Preferably, the image display means is arranged to display a video corresponding to at least part of the selected path. Preferably, the image display means is arranged to display photos corresponding to at least part of the selected path.

According to a twenty eighth aspect of the invention there is provided an electronic map interface having a plurality of selectable locations thereon, interface comprises path selection means for allowing a user to select a plurality of points, or sections, of road, forming a path between two locations, and an image display means is arranged to display images corresponding to at least part of the selected path.

Preferably, image display means is arranged to display images comprise one or more images of roadside landmarks, e.g. churches, pubs, or road related landmarks such as traffic lights, pelican crossings, along path. Preferably, the path selection means is arranged to allow a user to select at least part or a first road in combination with at least part of a second road. Preferably, the path selection means comprises a plurality of spaced points. Preferably, the path selection means comprises a plurality of selectable sections, each one spanning between two spaced locations. Preferably, the or each selectable location may comprise a polygon such as a square or circle to denote the location. Preferably, the map interface means comprises selection highlighting means to highlight a location or section or path that has been selected. Preferably, the selection highlighting means comprises means for colouring or shading a polygon denoting the selected location or the selected section. Preferably, the system comprises sequencing means to allow a user to sequence selected points or sections of path. Preferably, the selectable locations are visibly numbered for the user. Preferably, the image display means displays images of the points, sections, in a sequence corresponding to the sequence in which the points or sections were selected, e.g. as a sequential slideshow. Preferably, the electronic image displays system is arranged to display only images relating strictly to a selected path. Preferably, system comprises image slideshow or video relating to a location and means for allowing pause, fast forward, or rewind of the playback of a video or slideshow. Preferably, the system comprises map display means which can be displayed together with images displayed by the image display means. Preferably, as slideshow or video is played a cursor on map display means relating to location is moved. Preferably, map display means allows movement of cursor by user and cursor movement causes corresponding change in slideshow or video. Preferably, the map display means is arranged so that, as the image changes from point to point or section to section etc. the point or section is highlighted to inform the user of the whereabouts of the image. Preferably, system comprising a map and a still or moving image on a single split screen.

According to a twenty ninth aspect of the invention there is provided an electronic image storage and display system wherein system comprising a plurality of images of a plurality of locations, and means for displaying each of images, and when image is displayed a map is also displayed on (a split) screen.

Preferably, an image display means is arranged to display images at an angle transverse to the direction of the road. Preferably, an image display means is arranged to display images taken at an angle of less than 45 degrees to the plane of the ground. Preferably, an image display means is arranged to display images taken along a plane roughly parallel to the ground. Preferably, an image display means is arranged to display consecutive images taken at different angles to the road. Preferably, an image display means is arranged to display for each of a plurality of locations a plurality of photos at different angles to the direction of the road, e.g. at one location one image between 0 and 90 degrees to the left of the axis of the road, one image along the axis of the road, and one image at between 0 and 90 degrees to the right of the axis of the road. Preferably, system is arranged to allow a user to select one or more locations, and an image display means is arranged to displays a plurality of photos corresponding to the or each selected location. Preferably, an image display means is arranged to display at least one photo in a direction having an axis at an angle transverse to the axis of the road. Preferably, an image display means is arranged to display a photo taken in a direction having an axis between perpendicular and the direction along the road in the upstream direction. Preferably, an image display means is arranged to display a photo at an angle between forty five and minus forty five degrees to a horizontal plane. Preferably, an image display means is arranged to display at least one of the photos at an average angle of about twenty five and minus twenty five degrees to the plane. Preferably, the electronic location image storage system is internet-based. Preferably, system arranged to display distance of a selected path along with slideshow or video. Preferably, the system is arranged so that a user can select one or more locations simply with a click of a mouse. Preferably, the system comprises video display means and an audio track on video arranged to impart geography related data. Preferably, audio track arranged to inform of house number in image, extent of the domicile or office in image, style of housing in image, for sale or sold prices/dates of house in image, dimensions of house in image, historical information pertaining to buildings in image, opening hours of shops in image, Or example of major/local dialect used at the location, local estate agents at location, or other information relating to the location, if and where a selected path includes tolls or narrow roads, if and where a selected path includes road gradients, if and where a selected path is prone to traffic jams, if and where a selected path has traffic lights etc., or if and where houses currently for sale on path. Preferably, system comprises means for providing written information akin to that in Claim 178 relevant to location. Preferably, image display means comprises image(s) taken through window or inside building, and when image(s) through window or inside building is displayed, information relating to products and services of building can be displayed, e.g. overlaying image or on audio track. Preferably, information is price, size, colours, materials, source of goods, stock, or nearest real store, etc. Preferably, image of an item in a shop is shown, e.g. on rack, and user can click on icon to see item being modelled. Preferably, video display means is arranged to display for at least one selected location a video having images at different angles to the direction of the road, e.g. a video having some images which are in the direction of one side of the road and some images which are in the direction of the other side of the road. Preferably, image display means comprises video display means and video playback runs at about average human walking speed in metres per second, preferably shows journey time on basis of that speed. Preferably, user can input a walking speed, e.g. fast, medium, slow, or their own walking speed, to recalculate time for them to walk along the complete path. Preferably, system arranged to display distance of selected path along with video.

According to a thirtieth aspect of the invention there is provided an electronic location image display system comprising a plurality of still or moving images of locations, and location selection means for allowing a user to select at least one location, and an image display means which displays at least one image corresponding to the or each selected location, the images being taken in a direction other than perpendicular to the plane of the ground and downward.

Preferably, images are taken in a direction other than vertically downwardly.

According to thirty first aspect t of the invention there is provided an (internet based) electronic image storage and display system comprising journey input means which allows user to type in a start location and an end location, processing means which processes input, and retrieves images and display means which displays an image slideshow or video pertaining to the route or part or parts thereof.

Preferably, system stores locations of plural premises of a company name, system is arranged to receive a user entered postcode, zip code, address, or place name, and display means is arranged to display plurality of images, e.g. images of vicinity of building, or images of a route to or from, of the nearest premises from free or paid for car parking or public transport, e.g. train station.

According to a thirty second aspect of the invention there is provided an image recording apparatus for recording an image of a location, the apparatus comprising a global positioning system, transmission means for transmitting an image, and its GPS location, to a storage means, characterized in that the apparatus has a compass to measure the North, South, East, West direction in which image is recorded or the like.

Preferably, the GPS is arranged to notify a person such as a vehicle occupant to record images, other means of notifying occupant to record images at predetermined intervals, e.g. vehicle odometer, or system is arranged to automatically record images. Preferably, image recording system is arranged in or on a vehicle.

According to a thirty third aspect of the invention there is provided a method of constructing a database of images, the method comprising mounting an electronic image recording apparatus for recording (photo or video) images of a plurality of locations on a vehicle, moving the vehicle incrementally, recording an elevation image of a location at each step.

Preferably, method comprises arranging image recording apparatus to record images in a direction transverse to the direction of the road. Preferably, the step of moving the vehicle incrementally comprises moving between 1 m and 200 m, preferably every 10-50 m. Preferably, the of moving the vehicle incrementally comprises moving vehicle optimum amount along path so as to minimize overlap of images and avoid missing detail along path. Preferably, the method comprises recording a plurality of images at each location, e.g. in different direction or at different focal lengths. Preferably, method comprises storing image of each location. Preferably, method comprises storing GPS location of each image. Preferably, the method comprises transmitting the or each image, and its GPS location, to a remote storage means. Preferably, the method comprises transmitting date and/or time of recording image to storage means. Preferably, the method comprises transmitting the image with a direction in which the photo was taken. Preferably, the method comprises storing gps location of image in a manner such that gps location of image can be reviewed without opening image, e.g. so image location can quickly be checked before entry to an appropriate place in a database. Preferably, the method comprises submitting an image onto a map interface means, preferably submitting a plurality of images onto a map interface means. Preferably, the method comprises overwriting map interface means with GPS locations, e.g. to assist user in placing images thereon.

According to a thirty fourth aspect of the invention there is provided an image recording assembly comprising two image recording devices arranged to face in different directions so that each of the two image recording devices can record different images.

Preferably, the image recording devices are arranged at 90 degrees from one another, e.g. so that the first image recording device can record images in the direction up or down the road and the second image recording device can record images in the direction of a side of road. Preferably, the image recording devices are arranged at 180 degrees to face opposite directions, e.g. so that the first image recording device can record images of one side of the road and the second image recording device can record images of the other side of the road. Preferably, the image recording assembly comprises a third image recording device, and the third image recording devices is arranged at 90 degrees from first and third so that each of the three image recording devices can record different images. Preferably, the image recording assembly comprises a fourth image recording device, and the fourth image recording devices is arranged at 90 degrees from first and third and 180 degrees from second, so that each of the four image recording devices can record different images. Preferably, the image recording assembly is mounted on a movable object such as a vehicle or robot. Preferably, the image recording assembly comprises a distance measuring device such as an odometer and system is arranged to take images either at preset intervals or alert vehicle occupant to take an image. Preferably, the assembly comprises means for measuring real distance spanned by an image and assembly can take photos at intervals approximately equal to span of image or alert vehicle occupant to take an image. Preferably, the image recording assembly comprises a GPS sensor and one or more of the devices is arranged to take images at preset GPS locations or alert vehicle occupant to take an image. Preferably, the image recording assembly is arranged to take images either at preset time intervals or alert vehicle occupant to take an image at certain location. Preferably, the image recording assembly is voice operated. Preferably, the image recording assembly is remotely operated. Preferably, the image recording assembly is wirelessly operated. Preferably, the image recording assembly is arranged to take simultaneous recording of images. Preferably, the recording devices are connected to separate memories. Preferably, the assembly has a compass and can save direction in which image was taken along with image.

According to a thirty fifth aspect of the invention there is provided an image recording assembly comprising a screen arranged to display the extent of last recorded still image of a side of a road, and screen also being arranged to display a moving image of a side of a road corresponding to the image seen through the viewfinder.

Preferably, a screen does the same for another side of the road. Preferably, the image recording device has storage means and GPS which triggers display of existing image(s) held for the location in storage means, allowing user to survey a location to check if there has been a change in appearance of the location. Preferably, the image recording device has two (adjacent) screens allowing new image of the location and the old to be compared, on screens.

According to a thirty sixth aspect of the invention there is provided an electronic location image recording apparatus such as a mobile phone having an integrated or associated GPS receiver and an integrated or associated camera, the mobile phone being arranged to record an image, e.g. a photograph, of a location and (wirelessly) transmit the image of the location to a electronic database, the mobile phone also being arranged to transmit the location, e.g. in GPS form, at which location the photo was taken.

Preferably, apparatus is arranged to record images, e.g. a photograph, of a plurality of locations and transmit images of the locations, and to transmit the locations, e.g. in GPS form, or by text or by phone, at which location the photo or video was taken. Preferably, apparatus has a compass or the like and so is able to transmit direction in which the photo or video was taken.

According to a thirty seventh aspect of the invention there is provided an electronic location image storage system, comprising an apparatus according to thirty sixth aspect of the invention or consistory clauses relating thereto, and a central electronic database arranged to receive images from apparatus.

Preferably, photo or video is electronically stored in an approval bay. Preferably, system comprises a second storage means which can receive the image after quality verification. Preferably, system comprises means for sending user an electronic reward such as a password for access to a website or e.g. by being able to view images up to a certain memory for free or nominal amount. Preferably, a mobile phone is arranged to transmit a location at which an image is obtained to a first storage means, the mobile phone also being arranged to transmit an image of the location to a second storage means. Preferably, system is arranged to upload certain images from users straight onto a database of images to be viewed by the public, e.g. images of non-urban locations, or images from users who have good rating on previously submitted images. Preferably, system can become portable by storing images on laptop, P.D.A., or mobile phone memory or the like, for subsequent use. Preferably, laptop, P.D.A., or mobile phone memory or the like has an index of roads, sections of roads, points along roads, etc. and corresponding images, so user can view specific roads, sections of roads, points along roads, etc. Preferably, laptop, P.D.A., or mobile phone memory or the like has index of urban areas such as towns, cities. Preferably, system has security measures which restricts number of images which can be downloaded by a user. Preferably, system allows images of a predetermined maximum number of roads, predetermined total road length, or predetermined amount of memory to be downloaded.

According to a thirty eighth aspect of the invention there is provided an phone or computer having an image storage and display system, storage means storing a plurality of images, wherein the storage means comprising a plurality of images taken in a direction transverse to an axis of a road so as to show part of a side of a road, the system comprises a location selection interface arranged to allow a user to select a location, and the system is arranged to receive and process selection, and retrieve an image of a selected location from storage means.

Preferably, phone or computer comprises suitable software to carry out functions.

According to a thirty ninth aspect of the invention there is provided an computer program (e.g. on a carrier) which is arranged to read from an image the location at which image was obtained and the side of the road to which image relates, and means for storing the image at the appropriate location and side of the road on a map interface.

The electronic location image display system in accordance with the invention can provide an alternative to an image in the form of a vertically downward photo, which provides only limited information to a user. The electronic location image display system in accordance with the invention can complement a known location image display system. The electronic location image display system in accordance with the invention being able to show photos can beat the memory demands of video and webcams. The electronic location image display system in accordance with the invention provides a comprehensive yet an efficient means of storing elevation images of streets of urban cities in a manner same can be accessed and viewed in a predictable methodical manner. The invention can also afford more detailed and/or higher quality views than from air based objects.

It is thought the invention would be extremely useful for a city holding an event with lots of attendees, e.g. the Summer or Winter Olympic Games, a Football or Rugby World Cup, or a large exhibition or the like, in that the attendees can look at all locations and routes in an area before arriving, for example enabling them to preplan a route or make a more informed choice of hotel.

A location image display system and a method of obtaining an image of a location will now be described, by way of example only, and with reference to the following accompanying drawings, in which:—

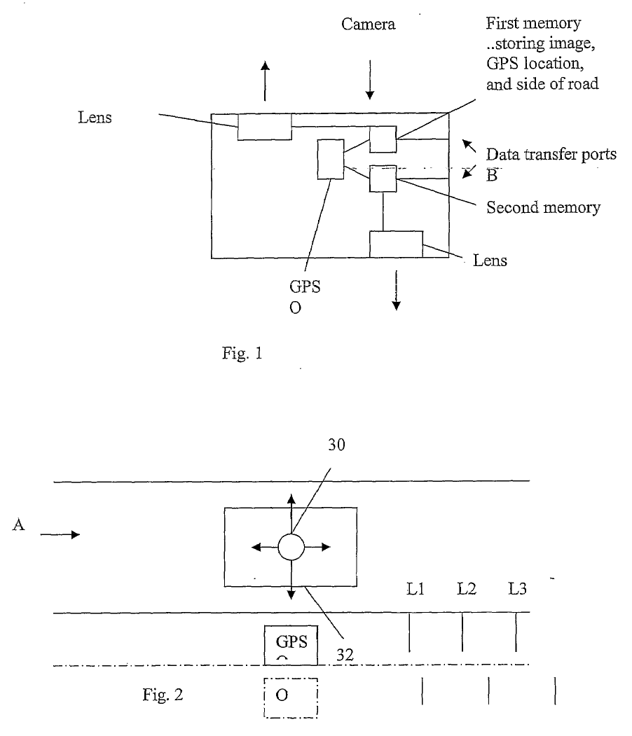

FIG. 1 is an image/video database construction tool kit,

FIG. 2 is an image recording assembly,

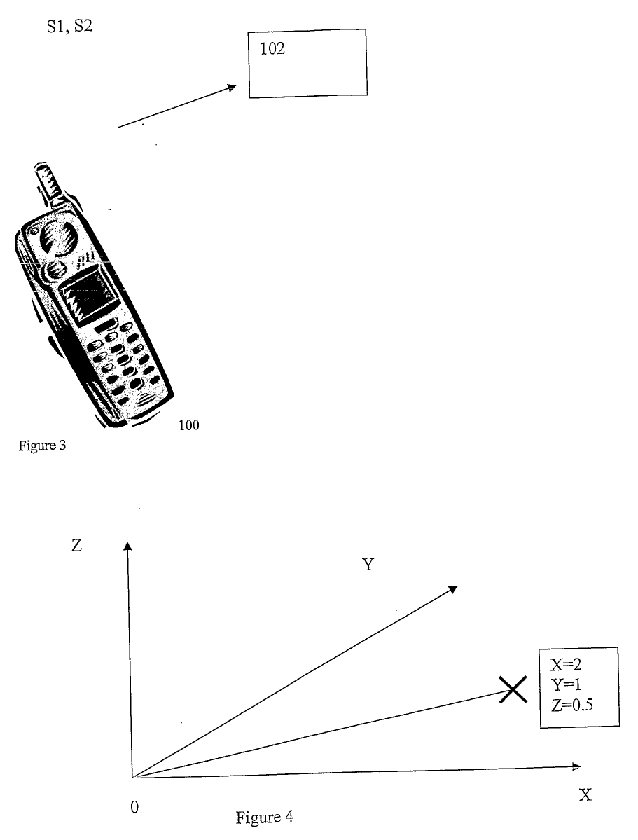

FIG. 3 shows an electronic location image recording system,

FIG. 4 simply shows the omni-directional aspect of the images,

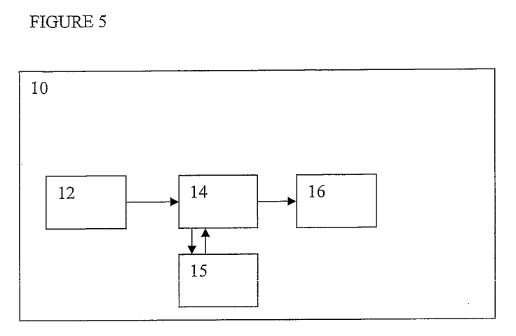

FIG. 5 shows an electronic location image display system in accordance with the invention,

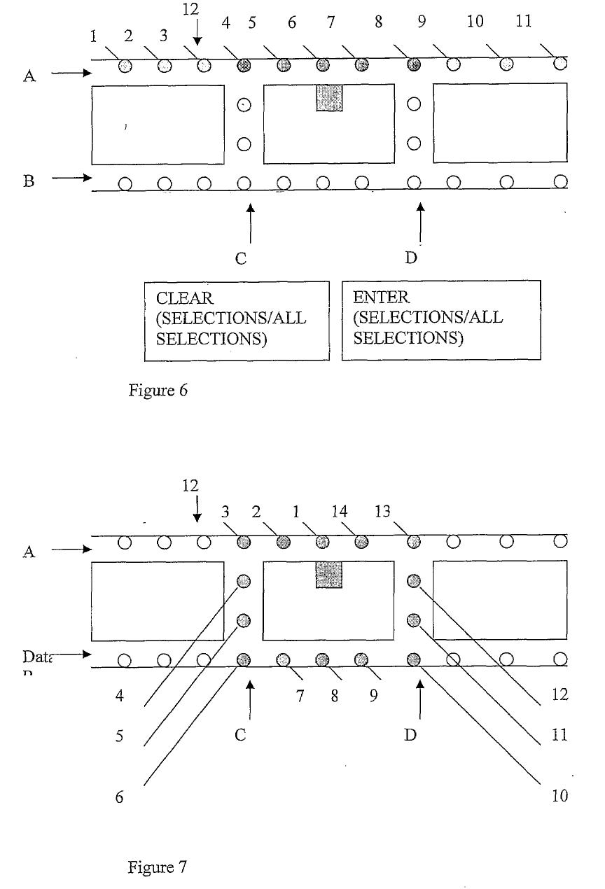

FIG. 6 shows part of an electronic location image display system in accordance with the invention, in particular selection means in the form of a map interface means having location markers associated with the roads, which users can select,

FIG. 7 shows another map interface means in accordance with the invention,

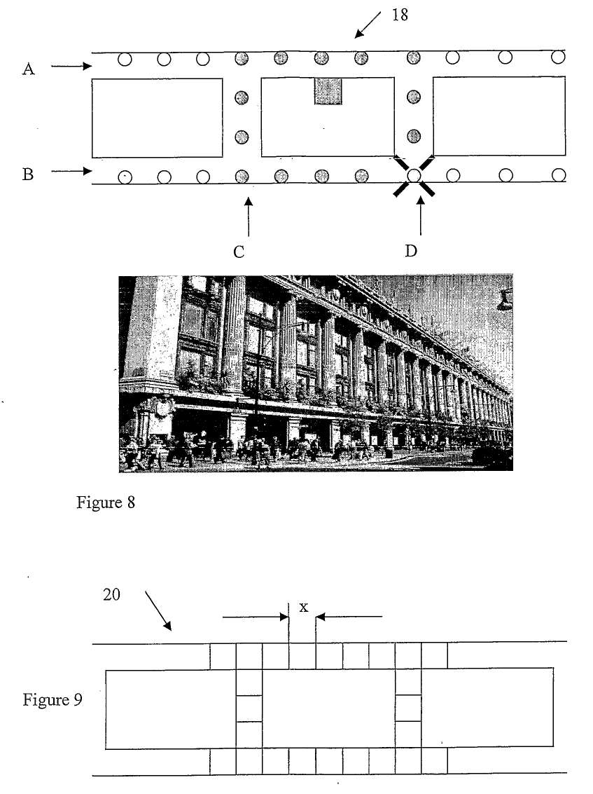

FIG. 8 shows another map interface means in accordance with the invention, and a photo display means,

FIG. 9 shows another map interface,

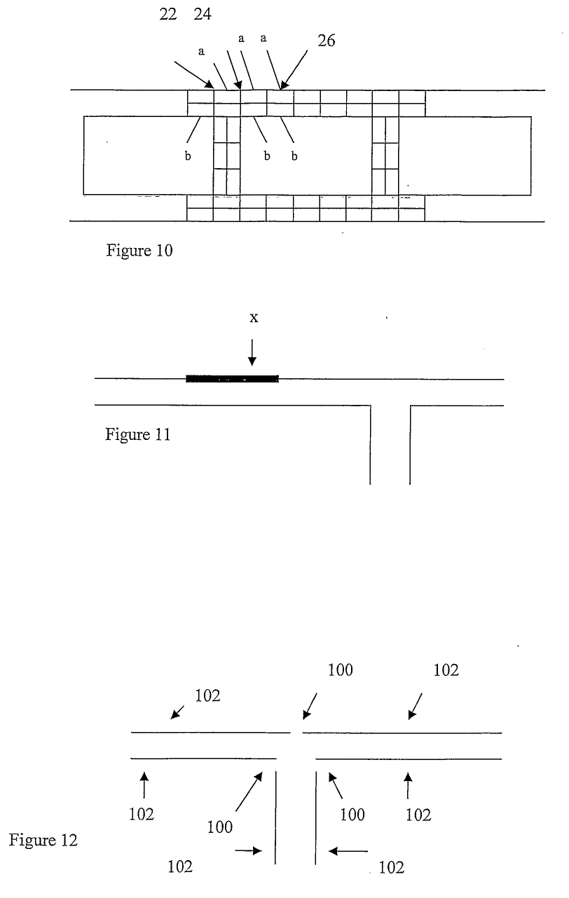

FIG. 10 shows yet another map interface,

FIG. 11 is another map interface means,

FIGS. 12, 13 and 14 show further map interface means,

FIG. 14a is a further map interface means,

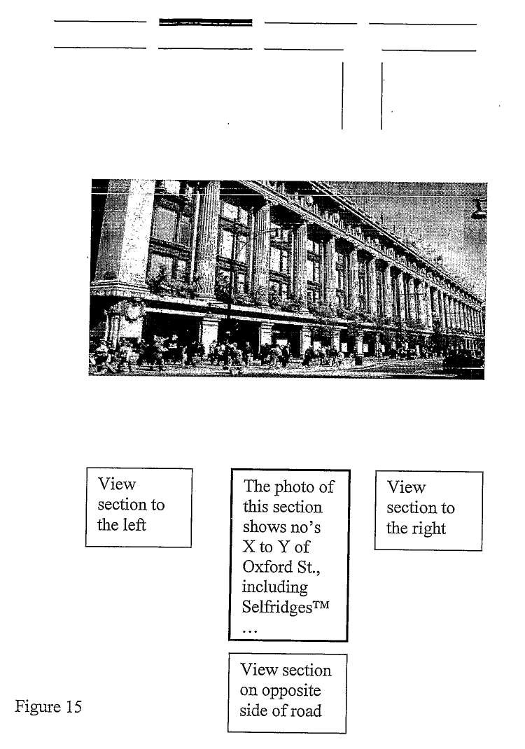

FIG. 15 is a display means of an image display system in accordance with the invention,

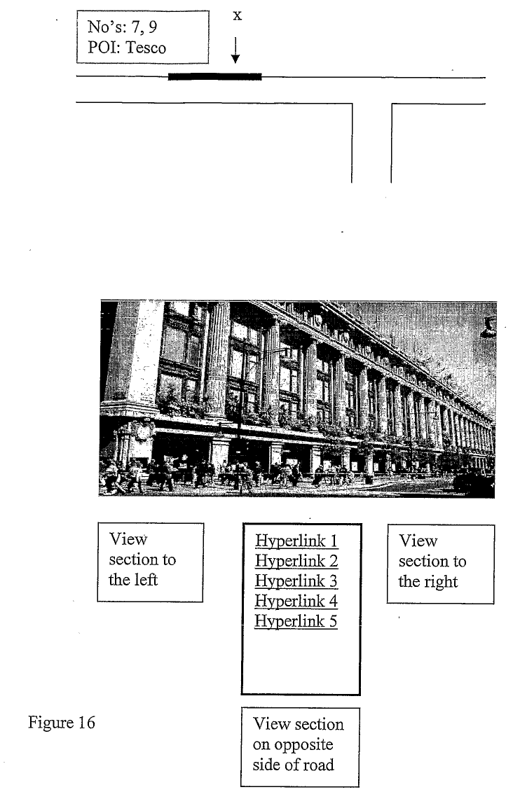

FIG. 16 is another display means of an image display system in accordance with the invention,

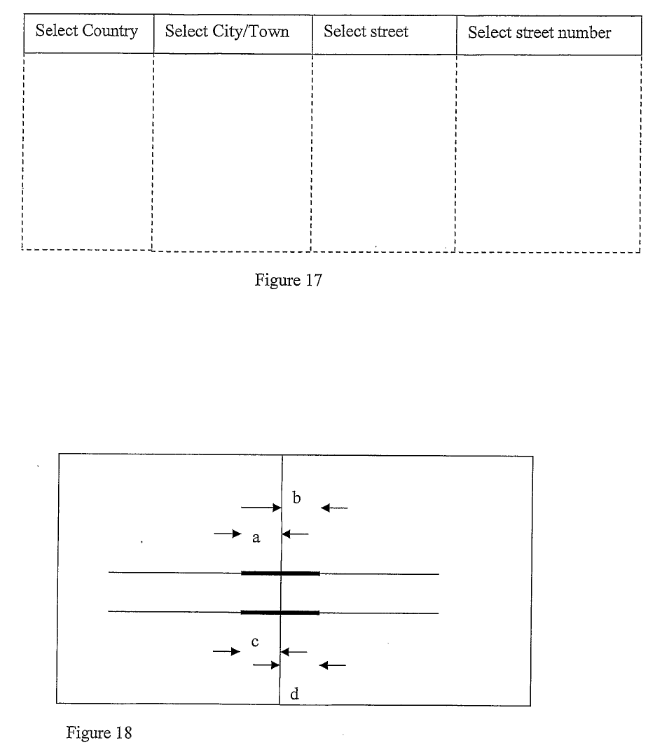

FIG. 17 shows a drop down type location selection means,

FIG. 18 shows a plurality of map parts, and how cells on different map parts can be navigated between,

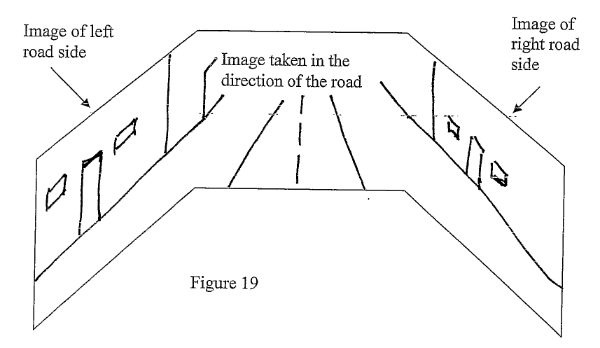

FIG. 19 is an exemplary embodiment which displays a plurality of images at any one time, in this three images, and in this case the images are sized and arranged at angles to create the feeling of a perspective view into a panorama, and

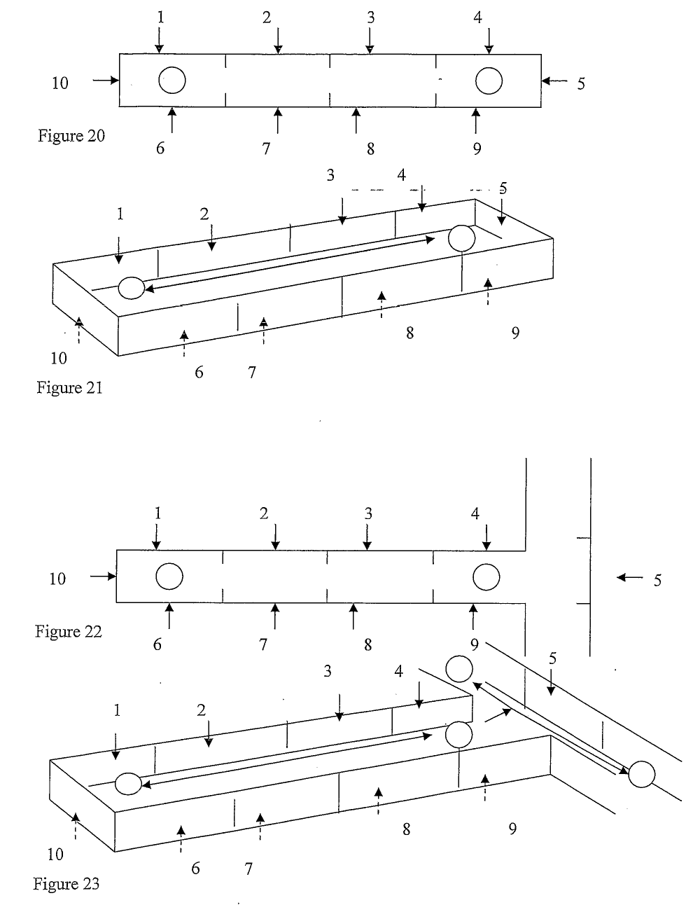

FIGS. 20 to 23 are further image display systems in accordance with the invention.

### THE OVERGROUND™ IMAGE DISPLAY SYSTEM

Images in the form of photographs and/or video can be obtained for the database.

Referring to FIG. 1, an image recording assembly comprises two photo recording devices, arranged at 180 degrees to one another so as to face opposite directions. Each of the two photo recording devices comprises known technology for capturing images. The recording devices are connected to separate memories. GPS sensor is connected to recording devices and memories. Suitable power supply means allow the assembly to function.

The image recording assembly can be vehicle mounted. In use, the image recording assembly is arranged so that the first image recording device faces one side of the road and the second image recording device faces the other side of the road. The GPS sensor is preset to trigger (simultaneous) recording of images at certain GPS locations. Images are stored in memories and GPS sensor communicates with the memories to so that location associated with each image is stored in memories. The individual memories ensure that images in each memory correspond to separate sides of the road. That allows for easier identification and sorting of images and uploading to display system.

In another embodiment of the invention, the image recording assembly can comprise a third image recording device. The third can be arranged at 90 degrees to face a middle direction.

The image recording assembly is arranged to take images at time intervals or at distance intervals or at preset GPS locations or at preset times.

The image recording assembly can be voice or otherwise remotely operated.

The (wireless) image recording device can comprise a screen which displays the last recorded still image, and a second screen which displays a video corresponding to the view to enable a user to determine the next image to be taken. In this way, the user can ensure the correct (i.e. minimal) amount of overlap from one image to the next. The first screen I adjacent second screen for easier analysis.

Instead of side of road, assembly can measure direction of image using compass. In this and other cases a single memory can be used to store images. In another embodiment of the invention, a movable robot housing an image recording assembly is used to capture images. Other suitable means can be used to allocate images to display system.

FIG. 2 shows a vehicle. In accordance with the invention, an image/video database construction tool kit 30 comprises a camera (with an optional variable focal length lens), a tripod (to be mounted for example on a vehicle-roof), a Global Position System (GPS) receiver, and appropriate software. The person constructing the image/video database simply places the camera onto the tripod and places the tripod on the top of a vehicle. The user drives the vehicle along a road to be recorded. Since the vehicle is generally close to the houses etc. adjacent the road, even known photographic system can allow “close up” images. The GPS receiver will at certain locations, by appropriate software, activate the camera to take photos at certain intervals marked by lines L1, L2, L3, e.g. every 50 metres. The camera, being on the vehicle, should be roughly in the middle of the road. The camera when activated can fully rotate to output a single 360 degrees seamless photographic non-stitched image. The recorded image can, via the software, integrate with a suitable back office system so that the image/video database is automatically and electronically stored. The database can be displayed on a website, thus allowing a person to check the video/images for quality etc. It is possible to isolate frames of a video, so as to minimize or overlap and maximize coverage.

The camera takes images the side of the road, for example object O at side of road. If the road is made wider, as shown by broken line, then the camera may be brought back from the side of the road being photographed, increasing the camera filed of view sideways along the road. Accordingly, intervals between taking successive images can increase, e.g. L1, L2, L3, is every 75 metres. An optimum interval distance gives no overlap or spaces in the material being photographed at the side of the road.

Alternatively, a vehicle or the system can have a device such as an odometer which measures distance covered accurately, and alert means to inform the vehicle occupant to take an image at certain location.

Referring to FIG. 3, in another embodiment of the invention an electronic location image recording system comprises a mobile telephone 100 and a central electronic database 102. The mobile phone 100 has an integrated or associated GPS receiver and an integrated or associated camera. A user of the mobile phone can photograph a location and transmit a photo of the location (by way of signal S1) to a database 102, the mobile phone also being arranged to transmit the location (by way of signal S2) to the database 102, e.g. in GPS form, at which location the photo was taken. The system can employ separate databases. The user of a non-GPS equipped phone can simply text or phone the location. The submitter of the photo can be rewarded e.g. by being able to view images up to a certain memory for free or nominal amount. The user can be allowed to upload an image onto a map, at least for certain locations, e.g. those which are more remote and which not otherwise be covered.

This system allows individual participation in creation and/or maintenance of database. The photo may be electronically stored in an approval bay, and upon approval, the user may be automatically electronically rewarded with a password for access to a website.

Referring to FIG. 4, a video taken at a particular location can be in any direction (i.e. X and/or Y and/or Z can be +ive or −ive), and an image taken at a particular location can be in any direction, except vertically downwardly.

Since road signs are generally perpendicular to direction of a road, photos can be taken in direction of road where road signs are at the side of the road.

Referring to FIG. 5, an electronic location image display system 10 comprises an internet-based location selection means 12 which allows a user to select a location, selection processing means 14, database of images (video or photo) 15, and a video display means 16 which displays a video corresponding to the selected location.

The internet-based location selection means 12 can be in the form of a map interface, as shown in FIG. 6.

Referring to FIG. 6, the map interface 12 comprises four roads A, B, C, and D. In practice, the (four) roads and/or buildings and/or places can be named but for conciseness in the drawings they are not. The map also shows a building which is schematically indicated by a shaded square.

In FIG. 6, the map interface 12 comprises (circular) location markers which are placed at ((approximately) regular) intervals along the length of each of the roads A, B, C, and D, conveniently placed on the roads themselves.

In use, a person can select the relevant location marker(s) of interest on the relevant road or roads. Once a location marker is selected it can be highlighted e.g. by shading the location marker as shown. For example, in FIG. 6, all of the location markers 1-11 on road A are selected. It should be noted that the location markers can be placed in a sequence by the user.

The location markers can be toggled on and off to select and deselect as appropriate. Alternatively, the user can press the CLEAR button to deselect the location markers. Once a user has finalized the location markers they can simply send the information relating to the selected location markers and the sequence of them to the selection processing means 14 by pressing the ENTER button.

Referring again to FIG. 5, the selection processing means 14 then communicates with the database of images (video or photo) 15 and generates a photo corresponding to each of the selected and entered location markers to be displayed to the user, in a sequence matching the selected sequence, on the video display means 16.

The selected location markers on the first map interface 12 can be stored and a second map interface means (not shown) can be brought up on a computer so that a user can select location markers on the second map interface means whilst the selected location markers on the map interface 12 are stored. When the user has finished, they can press ENTER to send all of the selected location markers on both map interfaces and the sequence of them to the selection processing means 14. Further map interface means can be employed. A user can scroll from first interface 12 to second.

In FIG. 7, part of roads A and B are selected and all of roads C and D are selected. The sequence is shown. Such a sequence of images can be useful to a person interested in acquiring the property shown. Once a user has finalized the location markers they can simply send the information to selection processing means 14. The processing means then generates a photo to be shown corresponding to each of the location markers.

As shown in FIG. 8, a map 18 comprising the selected location markers can be displayed whilst the series of photos is displayed, e.g. by splitting the display window. The series of photos is displayed in the order of the selected location markers. The map can comprise highlighting means for highlighting a location marker, and during the series of images, the highlighted location marker can denote the location at which a corresponding photo is currently being displayed, e.g. in FIG. 8 the bottom right selected location marker has a different shade, colour, size or other suitable indicia to show that the photo currently presented below relates to that precise location. For any given location, the map corresponding to the location can be shown along with the image of the location.

The method may alternatively comprise inputting a location or a plurality of locations in the form of a postcode, coordinate, street, and/or a town, onto one or more fields in a website, receiving and viewing a video or a plurality of photos of the locations.

In another embodiment of the invention, shown in FIG. 9, a map interface 20 has a road or roads divided into (rectangular)(approximately equal size) cells 22, 24, 26 etc. The cells touch end to end. Each cell can correspond to distance along the road X of say 5 m. A photo can be arranged to cover a distance of 5 m along the road and as such correspond to extent of the cell. Cells can be selected in roughly the same manner as above for FIG. 1 and a photo slideshow or a video can be displayed corresponding to the extent of the selected cells, for one or both sides of the road. The photo(s) is/are shown with a map showing selected cell.

As shown in FIG. 10, each cell 22, 24, 26 can be further divided into two parts 22a, 22b; 24a, 24b; 26a, 26b etc., one of which corresponds to one side of the road and the other of which correspond to the other side of the road. This enables a user to select the chosen side of the road to be viewed. Again, the photo(s) is/are shown with a map showing selected cell.

A road or roads on the map interface can have two or more sections running along its length, e.g. the road can be bisected at its centre longitudinal axis. One section can be divided into cells of length X, the other section can be divided into cells of length 2X. The different sized cells allow a different focal length of image or quality of image and can be selected accordingly by the user.

In the displayed image, relevant house numbers can be overwritten images or placed adjacent images so people know the exact property they are viewing. The author of the database can facilitate such labelling.

It is possible to pause, fast forward, or rewind the playback of a video or slideshow relating to a location, and when that is done, the selected locations on the map 18 do the same. One can do the reverse, i.e. move cursor on map to view video relating to location.

The invention presents a technical way of selecting and remotely viewing publicly accessible and/or outdoor location(s). The invention is also particularly useful when access to the location is difficult or undesirable, e.g. because of road traffic congestion or when the user is based in a different country and wishes to look at a possible location as a potential place of residence.

FIG. 11 shows a map interface whereby map retains continuity in borders because cells (only one of which, x, is highlighted) just overwrite certain sections of borders of roads marked on the map. i.e. a normal map is overwritten with cells or selectable sections or the like. The cell or selectable section or the like can be elongate and oriented to extend in the direction of the roadside at that part along the road. In this way, the road side seems to be a single uninterrupted line but with part of the border of the road seeming to appear bold, whereas in reality the cell line overwrites the road line. This interface has a tidy look and feel for the user.

FIG. 12 shows another embodiment of a map interface in accordance with the invention. As before, the interface can be part of a larger map. The map interface shows two roads in the form of a T junction. Breaks 100 in each side boundary of each road cooperate to define the lengthwise extent of selectable sections 102. Selectable sections 102 can be selected to lead to an image taken in the direction of that side of the road. The selectable sections 102 can change colour/shade/shape when mouse hovers over it so that the part can be easily discerned and change again when selected for viewing by for example a mouse click. Note, the breaks 100 should be optimised to be discernable to the user so that appropriate section can be selected but minimal so as to minimise effect on map continuity. Advantage of this map interface is that one can construct it simply by removing parts from an ordinary map as opposed to adding locations/cells to map. It also minimises the density of the map interface which makes it easier to comprehend. The border of the roads on the map need not have any breaks at all e.g. cells can be arranged end to end.

The selectable sections may be grouped in pairs, e.g. corresponding to opposite sides of the road. In this embodiment, images are not necessarily to one side of the road.

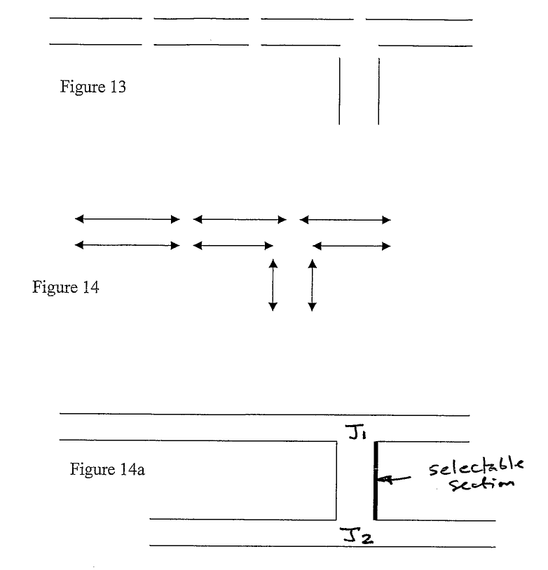

FIG. 13 shows another embodiment of a map interface. The selectable sections can be roughly the same length.

If the invention is arranged so that a video shows the entire length of a road, or from one junction to another, such information is clear from a map. The location along the road at which the video can be selected is not important, i.e. anywhere along its length. Hence, users can take videos along the entire length of a road, or from one junction to another, and they can be easily submitted onto a website with less scope for error and less need for verification. E.g. the user can simply click on a selectable section (s) as above, corresponding to the extent of the video along the road and submit the video.

FIG. 14 shows yet another embodiment of a map interface. The database creator (or user) can click on one appropriate arrow headed end of each selectable section to submit or view a video relating to the selectable section in the direction of the arrowhead (so that the video which is displayed relates to movement along the selectable section in the direction of the arrowhead). In this way, both sides of road and both directions along road can be methodically viewed.

Selection and sequencing in FIGS. 12 to 14 is carried out as in the embodiments above.

In another embodiment of the invention which is not shown for conciseness a user can simply click on a sequence of maps in order to get the map interface in the first place, zooming in appropriately. For example, one can start on a world map, optionally select a country, select a city, optionally select a sub city view, select a street, and optionally select a street number.

Referring to FIG. 15, as above, an image display system is arranged so that when a person selects a section (or part, cell, etc.) of a (road of or building of) a map, the photo is displayed covering the section (or part, cell, etc.). In addition, rather than returning to map interface, the window showing the photo (and section to which it relates) can have additional field(s) which allow a user to view section (or part, cell, etc.) on opposite side of road, and/or section (or part, cell, etc.) to left, and/or section (or part, cell, etc.) to the right. Data can be displayed stating what is in photo, e.g. house no's and/or landmarks included. The principle can be used after seeing a plurality of photos or frames of a video relating to a path or parts of a path along a road or roads to see corresponding part of opposite side of road. It will be appreciated that display of a single photo allows a large photo to be displayed giving maximum detail to user.

When the photo is displayed, the photo is accompanied by information. The information can be a list of points of interest etc. as mentioned herein. Points of interest can be listed as hyperlinks so user can go to website of point of interest. FIG. 16 shows such hyperlinks. In this way, user starts with map interface, dropdown or address data or unique IDS (country)(city) photo number to get to a photo and points of interest shown therein or relating thereto (e.g. note for one photo may inform user that a point of interest is in the photo relating to the opposite side of the road or nearby. The user can then click to go to the website to find more specific info relating to point of interest, e.g. opening hours, stock, prices.

FIG. 16 also shows map interface whereby map retains continuity in borders because cells just overwrite certain sections of borders. i.e. a normal map is overwritten with cells or selectable sections or the like. The cell or selectable section or the like can be elongate and oriented to extend in the direction of the roadside at that part along the road. In this way, the road side seems to be a single uninterrupted line but with part of the border of the road seeming to appear bold, whereas in reality the cell line overwrites the road line. This interface has a tidy look and feel for the user.

When a user hovers a mouse icon over a selectable section (or part, cell, etc.) the system can display the street no's caught in the photo relating to the section (or part, cell, etc.), e.g. “1-10” or 11-20”. Alternatively, the system can display the landmarks caught in the photo or points of interest corresponding to the photo. This gives a user greater means to choose section.

Photos can be stitched together to give a single photo showing a side of a road, or at least fewer independently viewable photos showing extent of road. Photos can be taken using minimum zoom on each street. Because some roads are wider than others, this means sections (or parts, cells, etc.) will be longer on some roads than others. In any event, when photo is displayed the user can have means to zoom in and out.

Photos can be taken showing part before and part after each road junction. Satellite navigation equipment can be loaded with images and have means to display a photo of the turning Point™ relating to a particular junctions or junctions on a particular route. This gives user a further indication as to when to turn. As mentioned above, landmarks adjacent road can be used on route instructions. Landmarks can be ranked for visibility. Most highly ranked can be used on route instructions where possible. If the landmarks used are very useful the system can get away with using less landmarks in the instructions.

The map interface can conveniently display street no's for each end of road, possible no at some point or points along road. This can combine with invention to facilitate easier searching.

Each photo has a (left hand side) photo start point and a (right hand side) photo end point, and the part of the photo between the photo start point and photo end point represents the extent of part of the side of the road captured in the photo. As mentioned above, it is important that the map interface has a map interface start point and a map interface end point, the map interface start point corresponding to the photo start point and the map interface end point corresponding to the photo end point, so that when the user clicks on the interface, the photo displayed truly reflects the extent of the part of the side of the road that it is said to cover. Obviously there are certain tolerances. The left hand side photo start point can be fixed at one end of the road. The right band side photo end point can be fixed at another end of the road. The left hand side photo start point and the right hand side photo end point, and optionally the mid point, of some photos can be fixed easily, if for example it includes a junction which is of course shown on the map interface. The space between the photos is then suitably divided into the selectable sections. Once the extent a selectable section is known or estimated, the start of each selectable section and the end of each selectable section can be measured as x, y coordinates. The start and end of the selectable section can then be accurately plotted on the map interface, if necessary using appropriate scaling if the map on which the x and y coordinates are measured differs from the scale of the map interface. The selectable section can then be drawn, for example using a Java® applet, between the two points. The selectable section can be drawn in a single step. It will be appreciated that the border of the roads on the map need not have any visible breaks at all yet the user can still select section after section. The selectable section is thus active, i.e. it has an altered state to the rest of the map. The selectable section can be drawn in the colour of the road border. Otherwise the road can look different.

Where the selectable section passes a junction, the cell can be drawn using a different colour.

The selectable sections X are programmed to stay hidden until a user hovers a mouse over the selectable section X. The selectable section X then appears. The selectable section can be arranged so that it is highlighted when the mouse con rolls over it. When the mouse rolls over the highlighted section can be wider than the width of the section, although naturally the length should be the same as the section length. This is done by listening to the mouse position and when it is placed on top of the cell its action listener is activated which makes the block visible on the map interface. This is also deactivated and made invisible when the mouse is moved away. This is done by turning the block invisible and removing all graphic components from it.

The selectable sections can vary according to the width of the road at the particular location along the road. The system can be programmed so that when the selectable section X appears the address (e.g. No: . . . ) and/or point of interest data (e.g. POI: . . . ) also appears, allowing the user to know what is in the images before formal selection. This can be done by automating a HTML type tool tip which becomes apparent as soon as the user hovers over a cell. HTML can be used to give the flexibly and various tags which allow the display of these addresses in a way which is attractive and easy for the user to read.

To formally view an image the user clicks on the selectable section X. The cell is highlighted in a different colour. This sis done by listening to the user's input and activating a listener which changes the colour of the cell from one (i.e. the selectable) colour e.g. red to another (i.e. the selected) colour e.g. blue, and activating the corresponding image to be displayed. This also makes the clicked cell activated in the sense that when the mouse is hovered out of the selected cell, the selected cell does not disappear. This feature allows a user to keep track as to where on the map the photo corresponds to. However, because the other cells are not deactivated, it is still possible to hover over the other cells and for the selectable cells to be shown in the other colour.

In FIG. 16, hyperlinks are shown. These can be shown instead of or in addition to the address (e.g. No: . . . ) and/or point of interest data (e.g. POI: . . . ) shown when the cell is hovered over as disclosed above.

Still referring to FIG. 16, below part, when the cell is selected by the user, the image and map showing selected cell is displayed. It will be noticed active buttons “view section to left”. “view section to the right” and “view section on opposite side f road” can be clicked on to allow the user to move to respectively the image to the left of the currently selected image, the image to the right of the currently selected image, and the image on the opposite side of the road to the currently selected image. The buttons can be replaced by pictorial images such as arrows pointing to the left to the right and up or down as applicable. In the case of crossing over the road this is done by pairing up images on one side of the road with images on the other side of the road and pairing them up so that when the cross over action is carried out the other in the pair is selected. Where there are a greater number of images of one side of the road than on the other the system is arranged to move the user to the closest cell to the or the last available image for that side. This feature is important because it allows a user to “walk down” the street and “cross over” the street.

The relevant address numbers and POI for each image are noted and stored for each image in the phases of obtaining and storing images. This allows the information to be programmed to appear later in the user interface.

Typically a camera photo has a long side and a short side. The long length of the photo is normally arranged lengthwise/horizontally to maximize lengthwise extent of photo. However, the long length of the photo can be arranged height wise/vertically so as to for example capture the full height of buildings adjacent the side of the road being photographed.

In order to cover a large geographical area and make cells sizeable enough, the user may be taken through maps of different resolution, starting on a low resolution map showing a large area. It is divided into a number of sections, each of which can be clicked on to expand the section. This allows honing in on a particular area, and a higher resolution map showing the smaller area. Finally, user hones in on the area of interest. It is in the final stage, at which cells can be selected.

The location markers and cells and selectable sections in FIGS. 8-14, etc. can be designed so that they only appear when a user navigates the mouse over the particular cell. The marker or cell can then be selected by a click.

Referring to FIG. 17, one can alternatively use dropdown menus to select the country, city, street, and street number. In this methodology, the selection process can start at country, city, or street, level. If beginning at Country level, a user clicks on the Select Country Box, and a menu drops down from which a country e.g. US is selected. Then a menu of country specific, i.e. US, cities/towns drops down and a user can click on one city/town to select it, e.g. Washington. Then a menu of city/town specific, i.e. Washington, streets drops down and a user can click on one street to select it, e.g. Pennsylvania Avenue. Then a menu of street specific, i.e. Pennsylvania Avenue, property numbers drops down and a user can click on one property number to select it, e.g. number 1600. The user can then view that property. This is all done without the user needing to navigate from one web page to another.

Sometimes, shops/buildings adjacent the road do not have a conventional numerical address. For such situations, instead of a property number, the point of interest is listed. All points of interest for a street are listed in a column like street numbers, and the column can combine street numbers and points of interest. Points Of interest are listed alphabetically.

As a variation of the method above one can select a country then bypass the city and select a street.

As another variation of the method in FIG. 17, one can begin at city level if there are not too many cities, or state (US meaning) or county level, or post code, zip code, or equivalent level. The latter can yield more than one road from which a single road can be selected.

As another variation one can bypass previous fields and go directly to Select street. It is known to type a street name and then be presented with a plurality of same or similar named streets in a country. In the invention, one can type a street name and data relating to more than one country is searched, and the street or streets with that name are presented to the user for selection. The country can be placed next to street name, as well as other known data such as town, to help a user identify the street they would like to see.

This is done by activating a cell and showing the image when the user selects a particular number or POI.

One can also modify the above method to allow selection of an individual apartment or the like in a building (this would follow the street number step) so that its position in the building can be ascertained, i.e. the floor on which it is located and its aspect.

Referring to FIG. 18, as mentioned above, a larger map can be divided into a plurality of map parts, each of which becomes a map interface. Roads will inevitably extend to more than one map part. Where a road reaches cell a on the north side of the road at the border of one map part (the home map part), the user is able to jump from cell a to neighbouring cell b on a neighbouring map part (the destination map part). Cells a and b must therefore be appropriately tied together. The same applies for cells c and d on the south side of the road. The same principle applies where other roads extend across two or more map parts.

It is possible to program the system to undertake a periodic review of images on database which highlights those images which are older than a certain age and in need of updating. A suitable computer program can facilitate that.

Map interface may show locations or cells that require an image, e.g. because there is no image or because existing image is out of date, by a different colour applied to cell/location or other suitable indicia, e.g. line thickness. User can then decide to update.

It is possible to display video and photo at each location depending on requirements.

It is possible to enter a plurality of addresses in website and for each location the system will give images and the map will display the location for the user.

It is advantageous to be able to select a location simply by clicking on the map itself, rather than typing a location in the form of an address etc.

The map interface means can be in 3 dimensional form. For example, buildings on a road can be simply and schematically rendered. The buildings can be shops. The shops can be named. The user can select (the fronts of) the buildings by clicking on them to a) zoom in and look through window or to b) “go in” the shop and look around the interior of the shop. Photos or images of shop fronts interiors can be submitted by shop owners or authorized person. In this way, there is perhaps less need to exert quality control.

The user could also simply click on a (or otherwise select a) 2 dimensional representation of the (shop) building or street adjacent building on a map interface, to view a photo or prerecorded or live video taken through window, one or a series of photos, or prerecorded or live video showing inside of shop, or link to a product catalogue, which can be browsed.

### ROBOSHOP™ Robot Shopping Apparatus

According to the invention there is also provided a user-via-internet controlled robot. An internet controlled robot, characterised in that the robot is arranged to store information of a plurality of products, and arranged to receive user enquiry for a product, robot haying recording device such as web cam and being arranged to move to location of product in store to allow a user to inspect the product via web cam image.

Hitachi™, Honda™, and Sony™ have unveiled humanoid robots called respectively Emiew™, Asimo™, and Qrio™. Shops or other buildings can have a video equipped robot stationed therein. From the comfort of their own home, the internet user can remotely guide the robot through building using a (simple virtual joystick on a webpage which allows a) direction command being any combination of forwards, backwards, left side, rights side, to be given to the robot by suitable electronic transmission means. In that way, user can walk around store to look at products for sale and prices etc. The robot can be confined to a predetermined route or free to move anywhere in the building, thereby catering to different users demands. The robot can “digest” numbers and descriptive data from a product catalogue, and locations of those products can be input to robot, e.g. using GPS. A user can type a keyword, e.g. “paint” causing robot to walk to the particular location of the paint section of the store. A specific product number can be given by user to robot for greater precision. The robot is able to (pick up the products and) examine them on behalf of the user, like a user might if they were in the store. The web camera is conveniently mounted at eye level. The robot can be configured to slow down or halt when approaching or proximate a human in the store. The system can be arranged that user pays for unit time of use of robot. The robot can even buy goods at checkout. Robot can be floor based or robot can be ceiling based. User can enter data related to purchase, e.g. VISA™ details. User can enter address data for delivery. The internet service provider possibly receives a commission relating to the transaction.

The robot can be a simple device which picks up items from various locations.

The robot can be replaced by a simple movable webcam, optionally mounted on an overhead rail in the store or like premises. User can adjust position of cam, direction of cam, zoom etc. Such a system allows viewing of items, although no interaction with products. Non movable webcam can also be used.

A webcam can be arranged to monitor the queue(s) in a store. A user near the store can then decide whilst for example in and adjacent store if they have time to queue and purchase an item in the store being viewed.

As opposed to a slideshow of multiple photo images, a plurality of photos can be displayed adjacent one another, e.g. side by side to give a continuous panoramic view.

The map interface is arranged to display the date of the selected image thereon. This helps to indicate to the user the likelihood of change to location. A system is enabled with date triggered reminder to ensure the authors are automatically reminded to update images at certain locations at certain times.

In accordance with the invention, one can use audio on video e.g. to inform house number, extent of the domicile or office, house prices, house dimensions, historical information pertaining to buildings, shop opening hours, or other information relating to the location. Also, the audio may be used to provide an example of major/local dialect used at the location. User can also be informed of sold price and date for specific houses and local estate agents, houses currently for sale, style of housing which can assist people not familiar with name of house type to widen their search to cover that type of housing. The system can inform a user if a selected path includes tolls or narrow roads, road gradients, when route is prone to traffic jams, existence of traffic lights etc.

For avoidance of doubt, route ways such as canals are included in the term road. Some cities e.g. Venice have such route ways instead of roads and so the two can be considered functionally equivalent. Any other realistic route way e.g. public footpath is also included.

The electronic display system can comprise a map and a video or image on a single split screen.

One can save a slideshow or video, and transfer to pc, laptop, P.D.A., or mobile phone memory or the like for subsequent use at home for guidance without connecting to internet or elsewhere for portable guidance. If images of a plurality of roads are downloaded, the roads may be indexed for single road selection and viewing in future. If more than one town is downloaded the towns too can be indexed. E.g. one can download all the streets of ones home town for easy reference.

The system has security measures which allow images of a maximum number of roads, total road length, or amount of memory to be downloaded.

In one embodiment of the invention, a map having at least one road divided into a plurality of regions, which are equal to the distance from road junction to road junction, exemplified by FIG. 14a. One can click on region and an image(s) relating to region is/are shown. Image(s) may show all of region, junction to junction.

In another embodiment of the invention, a database having images of at least one part, preferably all, of at least one side, preferably both, of at least one in every two roads, preferably substantially all roads, in a 0.1 km squared region (preferably 0.5, more preferably 1, most preferably over 10 kilometers squared), preferably most of major towns and cities, which may be in different countries.

Video playback can be at average human walking speed. User can input their own walking speed to recalculate time for them to walk along the complete path. One can display distance of selected path along with video/slideshow.

In accordance with the invention, the images displayed by the image display system may be pre-recorded photos or video or live video. As the pre-recorded video is played . . . there may be an option to select a live video of a specific area, by virtue of a webcam or the like, for example traffic lights, motorway junctions. This allows users to select the area to be viewed live.

In another embodiment of invention there is a wireless phone or wireless personal computer or home computer having storage means and software which enables storage of at least one image interface of one or more towns or cities (e.g. of a particular county (e.g. UK)), state ((e.g. US), or country), the or each image interface having roads which are individually selectable to enable playback of an image of the selected road.

In another embodiment of the invention, a user may search the image display system by entering a postcode, zip code, address, or place name to view a video of their nearest stores or outlets showing the building (and either the surroundings, or a route to or from parking or public transport).

It is known to take a photo and measure real span of photo from image. One can also do this using an object of known length and placing it in photo shot and calculating span of photo as multiplier of the object. One can photo one place, calculate span of photo and take photos at intervals approximately equal to span, possibly allowing for minimal overlap.

In another embodiment of invention, system is arranged to identify country of user of electronic device who is searching database e.g. using IP address or other means such as registration data from user, system is further arranged to monitor country of map viewed, and is arranged to provide advertising, now or later, specific or relating to the country or region of the selected map, for example flights from country of user to country of map, travel insurance for country of map, and/or national train/flights/bus/coach information if both countries are the same.

One can provide a video from a shop or business or building or landmark or the like nearest public transport service, e.g. train station or car park or free parking. One can video immediate vicinity of building.

When image(s) of shop window or inside of shop is being played, as discussed above, information relating to products and services can be displayed, e.g. overlaying image or on audio track. Typical information is price, size, colours, materials, source of goods, stock, nearest real store etc. where image of item in shop is shown e.g. on rack user can click on icon to see item being worn in a video.

In another embodiment, a map interface has roads that are broken down into cells or points or selectable sections like above. Map interface has a movable cursor which user can move along cells or points just by hovering over appropriate part of map interface and select one cell or point by clicking, and an image or video corresponding to the single cell or point will (immediately) appear. May be no need to press an enter button.

It is known to allow an internet user to type in a start location and an end location and see a route from the start location to the end location. In accordance with the invention, a user can provide a start location and end location and view an image slideshow or video pertaining to the route or part or parts thereof.

The location image display system and the method of obtaining an image of a location described herein are to the best of the inventor's knowledge at the time the best mode of use.

In one embodiment of the invention, a computer program (on a carrier) is arranged to read a GPS location from an image at which image was obtained, and place the image on an interactive map at a position corresponding to the location.

The database which has a field for names of a plurality of roads, and a field for storing at least one, preferably plurality, image(s) of a plurality of roads. The database has software which ensures no more than a preset no. of images, e.g. three, are held for a particular road side location. The database also has software which alerts when an image is over a certain age, e.g. more than three years old. The alert can happen more frequently at certain locations, e.g. when an image is over nine months old.

One can survey a location to check if there has been a change in appearance of the location, the image recording device has GPS which triggers display of existing image(s) held for the location. User can take new image of the location and the old and new can be compared, on adjacent screens. Alternatively, after image automatically appears the user can make a visual judgement as to if location has changed in appearance.

A road can be divided into a plurality of sections, each section being numbered. Images from recording device are also numbered as they are collected. Images and sections are then matched up.

Map can have address book data such as street numbers overlaying it, to assist user.

Three images can be stitched into a panoramic encircling field of view of the road of say 150 degrees (or whatever human filed of view equals). See FIG. 19. Other angles can be used. Images need not be stitched. Images can instead show part of field of view. As new images show new locations the new locations can be displayed with the new images at the same time.

User can click on any parts of map (not just roads, e.g. pavement, buildings adjacent roads or buildings in general) to show image of part, or a plurality of parts of map to show corresponding images. As an image is viewed a user can select to view an image relating to an adjacent location, e.g. “show image to left of current image” or “show image to right”. Video recorded images can be displayed in forward and reverse modes. Some people have no difficulty navigating to a location once they are in the road if such a road is a ‘dead end’ (a.k.a. cul de sac). Accordingly Images are obtained of every street which is linked to two or more streets because such a street is a potential route between the two or more streets. People who want to park there vehicle in a certain place can use this system. It may be desirable to survey a location to check if there has been a change in the appearance of the location. So Image recording device has gps triggering display of existing stored image for a location, and camera or the like to record new image of location, so old and new can be compared, e.g. on adjacent screens, or simply view location against old image to see if there has been a change.

A road can be divided into 5 metre long sections, and each cell divided into 2 subsections, one 4 each side of the road, and numbered, images can be numbered as they are collected, and matched up accordingly. Add address data e.g. road numbers to image or map. It can be possible to zoom in or out of photo. One can select city, then road, from dropdown menu. Manhattan and other US streets have a simple road layout, making it easy to obtain images for those areas.

### TURNING POINT™. Satellite Navigation Equipment

Satellite navigation equipment, such as in car satellite navigation equipment, can have the image storage and display system of the invention.

In one embodiment, a route (for example to be driven) is chosen, say from one side of London to the other side of London, and the system is arranged to retrieve and display one or more images of landmarks along the route.

Images can be accompanied by instructions relating to a particular landmark, e.g. “turn left after the Church on your left”. This allows a user to drive following visual clues, as we might obtain if a person were to instruct us in person on the street.

A user can touch the screen of satellite navigation equipment satellite navigation equipment so that an image is displayed of the location at which the satellite navigation cursor is positioned the time of contact, or voice command satellite navigation equipment so that an image is displayed of the location at which the satellite navigation cursor is positioned at the time of the command. Position of cursor on map can remain visible. E.g. image can overlay only a part of the satellite navigation map.

A user can enter a route and satellite navigation equipment can give image(s) of place at which you turn into final road to get to the destination, place at which you turn into penultimate road, place at which you turn into second last road etc.

As vehicle moves along route, user can simply request satellite navigation equipment “show me the next turn”, wherein image of roadside is shown at place where turn should be taken. This can avoid having to slow down at very junction a car approaches so as to look for a road sign, which of course may not even be present, unnecessarily slowing traffic. The image of part of a side of a road can be arranged so that the image is taken at a point which allows a user the required stopping distance for the upcoming junction, using average speed or the actual vehicle speed calculated. If actual speed is used one of several images can be displayed which allows user to have required stopping distance to junction.

The image can be displayed on the side of the driver corresponding to the object to be shown in image and/or the road into which the driver is to turn.

Image can be taken displayed at a location between top and bottom pf field of view, e.g. windshield, or may be adjacent thereto, or may be at eye level.

Image can be taken at an angle to the direction of the street, and angle can roughly correspond to the angle of the image display device in the vehicle with respect to the axis of the vehicle centreline (generally same as road axis).

Display of image can be removed after a preset time has elapsed. This avoids possibility of driver comparing image on display with roadside for excessively lengthy amount of time. Image can be displayed to passenger or passenger only.

In another embodiment, an Internet based road navigation system comprises an input means for a user to input a route between a first location and a second location. For example a user can input a start postcode and an end postcode. The system has uses a known technique e.g. like used by Via Michelin for calculating a route between the start postcode and an end postcode. The system also has an output means for displaying a map of the route between the first location and the second location and/or a list of roads to follow between the first location and the second location. The system also having means for retrieving an image from a database relating to one or more roads on the route, and means for displaying the image or images. This is done by creating a database containing a reference image for each road, e.g. of a prominent roadside landmark. The reference image(s) is/are displayed with the map/list so the user is informed to pass landmark. The system knows the direction of the route, and the system can instruct the user where the landmark should be positioned with respect to the driver, when the driver passes the landmark, e.g. as you pass the church it should be on right hand side.

An electronic location image display system can comprise a location selection means for allowing a user to select a plurality of locations, and means for generating a signal relating to the selected locations, selection processing means arranged to process the signal(s) relating to the selected locations and an image display means which displays an image corresponding to each of the selected plurality of locations.

At each location more than one image is displayed, preferably two or more, preferably three, the two or more images combining to increase the rotational field of view, to e.g. 150 degrees. Preferably the two or more images taken for each location are at 90 intervals, preferably images can be stitched together, most preferably seamlessly. When the images are displayed they can be displayed in such a way to give an impression of perspective. E.g. a rectangular image can be displayed with one foreground end longer than another background end.

The image(s) can be displayed in a preset border so as to ensure continuity of size of the image displayed.

Where a slideshow is used to display photos, the system is arranged such that the slide of last seen photo moves out of view, either immediately or gradually so as to cooperate with next photo to give a panorama, to the left if the next photo relates to a location to the right of the last displayed photo or to the right if the next photo relates to a location to the left, preferably both. This gives the impression of movement along the street, path, etc.

Plurality of locations can be selected before “packaging” video for display or one location can initially be selected then a further one or more by selecting appropriately.

Each photo has a first side border and second side border. border locations can be measured by gps. then the length of section on map corresponding to width of image (i.e. from border to border) can be accurately represented, or photo can be taken at location. The span of photo can be calculated and length of section can be represented on that basis.

An image display system can have a database of images, and the system can be arranged whereby each image has a unique number. The system can have unique numbers merely for each city so as to allow some replication. For example, a user can simply be given a number and after selecting the city, use that number alone, e.g. typed into number field, to get to the photo of a desired point in the city. This is often easier than typing in address data. Similarly, a system can have a database of images of a country, and the system can be arranged whereby each image has a unique number. Such a system can display any type of image.

FIGS. 20 and 21 show construction of a further image display system.

In FIG. 20, showing an extract of a 2-d map, each side of a road is divided along its length into a number of cells corresponding to how many photos it takes to photo the length, with no overlap and no spaces in the images photographed. For example if it takes four photos to capture the length of the road, the road is divided into four cells 1, 2, 3, and 4. Each end is divided into a number of cells corresponding to how many photos it takes to photo the width, for example just one cell 5. The other side of the road (cells 6-10) and the other end of the road (cell 10) are arranged in the same manner. The photos of the road side parts 1, 2, 3, and 4 can be digitally stitched and edited to give an apparently seamless image four cells wide.

In FIG. 21, “walls” are arranged according to the 2-d layout of the road, effectively making the 2-d map of FIG. 20 become 3-d. The area bounded by the walls is called a floor part since it represents just that.

Technology as used in video games to enable a person to move through a virtual landscape is used to allow a user to move along the length of the road and to face each side of the road from for example a first circle between cells 1 and 6 and adjacent cell 10, and a second circle between cells 4 and 9, and adjacent cell 5 as shown by the arrow in FIG. 21. In this way, the user can “walk” along a road, viewing a cell at a time, e.g., cell 1, then cell 2, then cell 3, etc. . . . The road can have images of buildings and shops etc. on a high street to create a virtual high street.

According to the invention there is an image display system comprising a three dimensional map, the map comprising two wall parts representing two opposing sides of a road, and a floor part representing the ground adjacent the road side, a plurality of images on each wall, positioned to reflect how the side of the road looks at the particular location, so as to make a substantially continuous image of each side of the road, and means to move along floor part so as to allow viewing of images and hence each side of the road.

Preferably the system comprises a plurality of inter connecting roads, allowing viewing of a plurality of roads.

A plurality of roads like that shown in FIGS. 20 and 21 can be added together to form a more complex 3-d map and image display system, as showed in FIGS. 22 and 23. A user can then “walk” from the first road into the further road in the directions shown by the arrows in FIG. 23.

The system can extend to cover as many roads as is desired. It should be noted that the 3-d map can match the road plan on a conventional map by e.g. ordnance survey. Indeed the 3-d map can be derived there from to ensure the accuracy of the 3-d map.

1. An electronic image storage and display system, the system comprising a storage means for storing a plurality of images, wherein the storage means comprising a plurality of images taken in a direction transverse to an axis of a road so as to show part of a side of a road, the system comprises a location selection interface arranged to allow a user to select a location, and the system is arranged to receive and process selection, and retrieve an image of a selected location from storage means.

2. An electronic image storage and display system for storing and displaying images of locations, the system comprising a storage means, the storage means comprising a plurality of still or moving images of a side of a road, the system comprises a location selection interface arranged to allow a user to select a location, and the system is arranged to receive and process selection, and retrieve an image of a selected location for display to a user, wherein each image of a location is taken at an angle perpendicular to the direction of the road, of a side of a road.

3. An electronic image storage system according to any preceding claim, wherein the storage means comprises an image or images of all of at least one side of a road.

4. An electronic image storage system according to any preceding claim, wherein the storage means comprises an image or images of at least part of both sides of a road.

5. An electronic image storage system according to any preceding claim, wherein the storage means comprises a first image showing at least part of a first side of a road, and a second image showing at least part of a second side of a road.

6. An electronic image storage system according to any preceding claim, wherein the storage means comprises a first image which shows only a first side of a road, and a second image which shows only a second side of a road.

7. An electronic image storage system according to any preceding claim, wherein the storage means comprises images of the total length of a first side of a road and part of a second side of the road.

8. An electronic image storage system according to any preceding claim, wherein the storage means comprises images of the total length of both sides of a road.

9. An electronic image storage system according to any preceding claim, wherein the storage means comprises images taken at or adjacent a plurality of roads of part of at least one side of a plurality of roads.

10. An electronic image storage system according to any preceding claim, wherein the storage means comprises images of all of at least one side of a plurality of roads.

11. An electronic image storage system according to any preceding claim, wherein the storage means comprises images showing at least part of both sides of a plurality of roads.

12. An electronic image storage system according to any preceding claim, wherein the storage means comprises a first image showing at least part of a first side of a first road, and a second image showing at least part of a second side of a first road, a third image showing at least part of a first side of a second road, and a fourth image showing at least part of a second side of a second road (etcetera).

13. An electronic image storage system according to any preceding claim, wherein the storage means comprises a first image which shows only a first side of a road, and a second image which shows only a second side of a road, a third image showing at least part of a first side of a second road, and a fourth image showing at least part of a second side of a second road (etcetera).

14. An electronic image storage system according to any preceding claim, wherein the storage means comprises images of the total length of a first side of a road, and part of a second side of the road, and part of a first side of a second road, and part of a second side of a second road.

15. An electronic image storage system according to any preceding claim, wherein the storage means comprises images of the total length of a first side of a road, and part of a second side of the road, and total length of a first side of a second road, and part of a second side of a second road.

16. An electronic image storage system according to any preceding claim, wherein the storage means comprises images of the total length of a first side of a road, and total length of a second side of the road, and total length of a first side of a second road, and total length of a second side of a second road.

17. An electronic image storage system according to any preceding claim, wherein the storage means comprises separate images showing each side of each road.

18. An electronic image storage system according to any preceding claim, wherein the storage means comprises images covering total length of both sides of roads.

19. An electronic image storage system according to any preceding claim, wherein the storage means comprises images taken at or adjacent at least ten different named roads.

20. An electronic image storage system according to any preceding claim, wherein the storage means comprises images taken at or adjacent at least fifty different named roads.

21. An electronic image storage system according to any preceding claim, wherein a plurality, preferably the majority, most preferably all, of images in the storage means span up to, but no more than, the full extent of a road.

22. An electronic image storage system according to any preceding claim, wherein the storage means comprises a plurality of images taken at intervals in excess of 0.5 m or so that each of a plurality of images spans at least 0.5 m.

23. An electronic image display system according to any preceding claim, wherein the storage means comprises a plurality of images taken at intervals of less than every 200 m or so that each of a plurality of images spans less than 200 m.

24. An electronic image display system according to any preceding claim, wherein the storage means comprises a plurality of images taken at intervals of between 1 m and 200 m or so that each of a plurality of images spans at least 0.5 m and less than 200 m.

25. An electronic image display system according to any preceding claim, wherein the storage means comprises a plurality of images taken at intervals of between 10-100 m or so that each of a plurality of images spans at least 10 m and less than 100 m.

26. An electronic image display system according to any preceding claim, wherein the storage means comprises a plurality of images taken at intervals of between 20-50 m or so that each of a plurality of images spans at least 20 m and less than 50 m.

27. An electronic image display system according to claim 16, wherein the storage means comprises a plurality of images taken at regular intervals or so that they cover equal distances.

28. An electronic image storage system according to any preceding claim, wherein the storage means comprises a plurality of images taken at successive locations along a road and which, can be viewed, either individually, as a plurality or as a whole, to provide a panorama of a side of a road.

29. An electronic image storage system according to claim 28, wherein the storage means comprises a plurality of images forming a panorama of both sides of a road.

30. An electronic image storage system according to claim 28, wherein the storage means comprises images forming a panorama of a side of plurality of roads.

31. An electronic image storage system according to claim 28, wherein the storage means comprises images forming a panorama of both sides of a plurality of roads.

32. An electronic image storage system according to any of claims 28 to 31, wherein storage means comprises a plurality of images for which there are no gaps between images.

33. An electronic image storage system according to claim 32, wherein storage means comprises a plurality of images which have less than 20% overlap, by content of image, with any image covering an adjacent view.

34. An electronic image storage system according to claim 32, wherein storage means comprises a plurality of images which have negligible or no overlap, by content of image, with any image covering an adjacent view.

35. An electronic image storage system according to any preceding claim, wherein the storage means comprises images covering a road length of at least 0.5 km.

36. An electronic image storage system according to any preceding claim, wherein the storage means comprises images covering a road length of at least 1 km.

37. An electronic image storage system according to any preceding claim, wherein the storage means comprises images covering a road length of at least 10 km.

38. An electronic image storage system according to any preceding claim, wherein the storage means comprises images covering a road length of at least 100 km.

39. An electronic image storage system according to any preceding claim, wherein the storage means comprises at least one image, preferably a plurality of images, of every public road, connected to two or more other roads, in a 0.25 km² urban area.

40. An electronic image storage system according to claim 39, wherein the storage means is arranged to store at least one image, preferably a plurality of images, of all public roads in the urban area.

41. An electronic image storage system according to claim 39 or 40, wherein the urban area is at least 0.5 km².

42. An electronic image storage system according to claim 39 or 40, wherein the urban area is at least 1 km².

43. An electronic image storage system according to claim 39 or 40, wherein the urban area is at least 5 km².

44. An electronic image storage system according to claim 39 or 40, wherein the urban area is at least 10 km².

45. An electronic image storage system according to any preceding claim, wherein at least one of the images in the storage means is taken from a (movable) ground based object.

46. An electronic image storage system according to claim 45, wherein at least one image of each of a plurality of roads in the storage means is taken from ground based object.

47. An electronic image storage system according to claim 45, wherein each image in the storage means is taken from a ground based object.

48. An electronic image storage system according to any preceding claim, wherein storage means comprises a plurality of images taken at an angle along axis of the road, i.e. in the direction of the road.

49. An electronic image storage system according to any preceding claim, wherein storage means comprises a plurality of images taken at an angle perpendicular to the direction of the road.

50. An electronic image storage system according to any preceding claim, wherein storage means comprises a plurality of images taken at an angle between the axis of the road and an angle perpendicular to axis of road.

51. An electronic image storage system according to any preceding claim, wherein storage means comprises a plurality of images taken at an angle of between 85 degrees above the plane of the ground and 85 degrees below the plane of the ground.

52. An electronic image storage system according to any preceding claim, wherein storage means comprises a plurality of images taken at an angle between forty five above the plane and the horizontal plane.

53. An electronic image storage system according to any preceding claim, wherein at least one of the images in the storage means is images taken in a direction roughly parallel to the ground.

54. An electronic image storage system according to any preceding claim, wherein the storage means comprises images showing an end to end panorama corresponding to the total length of a loop of road.

55. An electronic image storage system according to any preceding claim, wherein the electronic image storage system comprises a second (separate) storage means which is arranged to store a plurality of locations, e.g. successive points, sections along the length of a road, or roads, corresponding to locations at which images stored in storage means were taken.

56. An electronic image storage system according to claim 55, wherein images are numbered.

57. An electronic image storage system according to claim 56, wherein storage means comprises images of end to end sections of a road loop.

58. An electronic image storage system according to claim 57, wherein end to end sections of road loop are numbered in a sequence.

59. An electronic image storage system according to claim 57 or 58, wherein images of sections of road loop comprise images of a plurality of different named roads.

60. An electronic image storage system according to any preceding claim, wherein the system is arranged to store the dates on which images of at least one road were obtained.

61. An electronic image storage system according to any preceding claim, wherein the system comprises images of plurality of roads and is arranged to store the dates on which images of all roads were obtained.

62. An electronic image storage system according to claim 60 or 61, wherein the system comprises means for reviewing age of images in storage means.

63. An electronic image storage system according to claim 62, wherein system comprises alert means arranged to alert if age of an image exceeds a predetermined threshold, preferably location of aged images given, most preferably via a map.

64. An electronic image storage system according to any preceding claim, wherein the system comprises notification means for notifying that the system has more than a preset no. of images for a particular location.

65. An electronic image storage system according to any preceding claim, the display system comprising a location selection means for allowing a user to select and input a location, and means for receiving a signal relating to the selected location, selection processing means, arranged to process the signal(s) relating to the selected location and an image display means arranged to display an image corresponding to the selected location.

66. An electronic location image storage system according to claim 65, wherein the image display means comprises a video display means which displays a video corresponding to the selected location.

67. An electronic location image storage system according to claim 65 or 66, wherein the image display means comprises a photo display means which displays a photo corresponding to the selected location.

68. An electronic image display storage according to claim 65, wherein the location selection means is arranged to allow a user to select and input a plurality of locations, and means for receiving a signal relating to the selected locations, selection processing means arranged to process the signal(s) relating to the selected locations and an image display means which is arranged to display an image corresponding to each of the selected plurality of locations.

69. An electronic image storage system according to claim 68, wherein the image display means comprises a video display means which is arranged to display a video corresponding to the selected locations.

70. An electronic image storage system according to claim 68, wherein the image display means comprises a photo display means which is arranged to display a photo corresponding to the selected locations.

71. An electronic image storage system according to any of claims 65 to 70, wherein the system is arranged to display the date on which one or a plurality of images are obtained to the user.

72. An electronic image storage system according to any preceding claim, wherein storage means comprises one or more images taken from a pavement or the like adjacent the road, or the road itself.

73. An electronic image storage system according to claim 72, wherein storage means comprises one or more images of a side of a road taken from a pavement on an opposite side of a road to the object of the image.

74. An electronic image storage system according to any preceding claim, wherein the location selection means comprises a data field arranged to receive a user entered keyword such as all or part of a street name to obtain an image of that location, or a list of results from which one location can be selected and viewed.

75. An electronic image storage system according to any preceding claim, location selection means comprises a dropdown menu so that a user can select the name of a street they want to view.

76. An electronic image display system according to any preceding claim, wherein location selection means comprises a dropdown menu so that a user can select the number of an address on the street.

77. An electronic image storage system according to any preceding claim, wherein location selection means comprises dropdown menu so that a user can select the name of an urban area such as a city, town or the like.

78. An electronic image storage system according to any preceding claim, wherein the location selection means comprises dropdown menu so that a user can select the name of a country.

79. An electronic image storage system according to any preceding claim, wherein location selection means comprises GPS field and means for reading GPS so as to provide view of correct location.

80. An electronic image storage system according to any preceding claim, wherein the system is arranged so that a user can use dropdown menus to select the name of a country, and a menu drops down from which a country is selected, then a menu of country specific cities/towns drops down and a user can click on one city/town to select it then a menu of city/town specific streets drops down and a user can click on one street to select it, then a menu of street specific property numbers drops down and a user can click on one property number to select it.

81. An electronic image storage system according to any preceding claim, wherein the location selection means comprises map means.

82. An electronic image storage system according to claim 81, wherein the location selection means comprises map interface means.

83. An electronic location image storage system according to claim 82, wherein the map interface means comprises one selectable location thereon which allows a user to select one location on the map interface means.

84. An electronic image storage system according to claim 83, wherein the selectable location is a road, section of a road, or point along a road, or like pathway or other route way such as a waterway, or a building adjacent a road.

85. An electronic location image storage system according to claim 82, wherein the map interface means comprises a plurality of selectable locations thereon, which allows a user to select one of a plurality of locations on the map interface means.

86. An electronic image storage system according to claim 85, wherein the map interface means comprises individually selectable roads, or like pathways, or other route ways such as a waterways, or buildings adjacent a road.

87. An electronic image storage system according to claim 86, wherein an image display means is arranged to display one or more images corresponding to the selected road or roads.

88. An electronic location image storage system according to claim 87, wherein the image display means is arranged to display an image such as a video corresponding to at least part of the selected road or roads.

89. An electronic location image storage system according to claim 87, wherein the image display means is arranged to display an image such as a video corresponding to the total length of the selected road or roads.

90. An electronic location image storage system according to claim 87, wherein the image display means is arranged to display an image such as a video showing both sides of the selected road or roads.

91. An electronic image storage system according to claim 85, wherein the plurality of selectable locations comprises a plurality of spaced points on or adjacent at least one of the roads on the map interface means.

92. An electronic location image storage system according to claim 91, wherein the map interface means comprises spaced points on or adjacent all of the roads on the map interface that are connected to at least two other roads.

93. An electronic location image storage system according to claim 91, wherein the map interface means comprises spaced points on or adjacent all of the roads.

94. An electronic location image storage system according to claim 91, 92, or 93, wherein the spaced points are spaced roughly equally along the or each road.

95. An electronic location image storage system according to any of claims 83 to 85, wherein the map interface means comprises two spaced apart locations, defining a selectable section spanning two spaced locations, and a means for allowing a user to select the section, preferably further spaced apart locations defining further selectable section or sections.

96. An electronic location image storage system according to claim 85, wherein the map interface means comprises at least one road divided into a plurality of selectable lengthwise sections.

97. An electronic location image storage system according to claim 95 or 96, wherein map interface means comprises a plurality of selectable lengthwise sections extending consecutively along part of road length, preferably each selectable lengthwise section extending consecutively along part of road length.

98. An electronic location image storage system according to claim 95, 96, or 97, wherein all of the roads on the map interface means that are connected to at least two other roads comprise a selectable lengthwise sections, preferably each extending along part of road length.

99. An electronic location image storage system according to any of claims 95 to 98, wherein the majority, preferably all, of the public roads on the map interface means comprise a plurality of selectable lengthwise sections, each extending along part of road length.

100. An electronic location image storage system according to any of claims 95 to 99, wherein plurality of selectable lengthwise sections are of regular length.

101. An electronic location image storage system according to any of claims 95 to 100, wherein plurality of the selectable lengthwise sections are arranged end to end.

102. An electronic location image storage system according to any of claims 95 to 101, wherein plurality of lengthwise sections run from road junction to road junction.

103. An electronic location image storage system according to any of claims 95 to 101, wherein at least one selectable lengthwise section is defined by two breaks in a boundary of a road.

104. An electronic image storage system according to claim 103, wherein one or more roads of map interface means comprises at least one selectable lengthwise section in at least one side of a road.

105. An electronic image storage system according to claim 103 or 104, wherein map interface means comprises at least one selectable lengthwise section in each side boundary of a road.

106. An electronic image storage system according to any of claims 103, 104 or 105, wherein map interface means comprises further breaks defining further selectable lengthwise sections on both sides of a plurality of roads.

107. An electronic image storage system according to any of claims 103 to 106, wherein map interface means comprises at least one selectable lengthwise section in each road.

108. An electronic image storage system according to any of claims 103 to 107, wherein breaks are minimal thereby not excessively disrupting map border continuity.

109. An electronic image storage system according to any of claims 103 to 108, wherein selectable sections can change colour/shade/shape when selected, or when a computer mouse hovers over it.

110. An electronic image storage system according to any of claims 103 to 109, wherein at least two of the selectable sections are grouped in a pair, e.g. corresponding to opposite sides of a road.

111. An electronic image storage system according to any of claims 103 to 110, wherein selectable section has arrow headed end or the like.

112. An electronic image display system according to any of claims 85 to 111, at least one, preferably a plurality of selectable sections, links to an image of the selectable section, preferably taken in the direction of the side of the road.

113. An electronic image storage system according to any of claims 85 to 111, wherein selectable points or sections comprise a polygon such as a triangle, rectangle or circle to denote it.

114. An electronic image storage system according to any of claims 85 to 111, wherein image display means is arranged to display an image or images relating to entire extent of one or more lengthwise section.

115. An electronic location image storage system according to any of claims 85 to 111, wherein image display means is arranged to display a single image which shows entire extent of lengthwise section.

116. An electronic location image storage system according to claim 115, wherein the location selection means comprises selectable locations at a frequency of more than every 0.5 m or selectable sections covering lengths of a road of more than 0.5 m.

117. An electronic location image storage system according to claim 115 or 116, wherein location selection means has selectable locations at a frequency of less than every 200 m or selectable sections covering lengths of a road of less than 200 m.

118. An electronic location image storage system according to claim 117, wherein location selection means has selectable locations at a frequency of between 1 m and 200 m or selectable sections covering lengths of a road of between 1 m and 200 m.

119. An electronic location image storage system according to claim 117, wherein location selection means has selectable locations at a frequency of between 10-50 m or selectable sections covering lengths of a road of between 10 m and 50 m.

120. An electronic image storage system according to any of claims 82 to 119, wherein the map interface means is arranged so that at least one road, e.g. a road of great popularity or importance such as 5^{th} Avenue in New York or Oxford Street in London, is provided with two or more sets of selectable locations, sections, or paths, along its length.

121. An electronic image storage system according to claim 120, wherein the first set of selectable locations is arranged to cover a greater number of selectable locations along its length to the second set.

122. An electronic image storage system according to claim 121, wherein the first set offers more detailed images than the second set.

123. An electronic image storage system according to claim 121 or 122, wherein the first set is arranged to process views in a different direction, e.g. north facing, to the second set, e.g. south facing.

124. An electronic image storage system according any of claims 82 to 123, wherein the map interface means has numbering means for numbering in sequence selected sections or points, and sequencing means ensure images are played in same sequence.

125. An electronic image storage system according to any of claims 82 to 124, wherein the map interface has roads that are broken down into cells or points or selectable sections, and map interface has cells or points that can be selected by hovering mouse there over and clicking to select a cell or point, and image display means is arranged to an image corresponding to the cell or point.

126. An electronic image storage system according to any of claims 82 to 125, wherein map interface comprises selectable selections covering entire length of a road.

127. An electronic image storage system according to any of claims 82 to 126, wherein map interlace comprises selectable selections covering both sides of a road.

128. An electronic image storage system according to any of claims 82 to 127, wherein system comprises means for entering an address (e.g. on website) and image display means arranged to display images and map of location.

129. An electronic image storage system according to claim 128, wherein system comprises means for entering plurality of addresses, and image display means arranged to display plurality of images and map (s) showing locations.

130. An electronic image storage system according to any of claims 82 to 129, wherein system arranged so that a user can simply click on a map, or sequence of maps, in order to get the map interface in the first place, zooming in appropriately.

131. An electronic image storage system according to claim 130, wherein one can start on a world map, optionally select a country, select a city, optionally select a sub city view, select a street, and optionally select a street number.

132. An electronic image storage system according to any of claims 82 to 131, wherein system arranged to inform of locations on map interface that require an image, e.g. because there is no image or because existing image is out of date, for example by applying a different colour, line thickness or other suitable indicia, applied to cell, section or point.

133. An electronic image storage system according to any preceding claim, wherein system has reception means arranged to be able to receive an image of a location from a remote user.

134. An electronic image storage system according to any of claims 82 to 131, wherein the map interface means comprises a three dimensional map.

135. An electronic image storage system according to claim 134, wherein shapes of buildings such as shops on a road can be simply and schematically rendered.

136. An electronic image storage system according to claim 135, wherein the shops are labeled with their name.

137. An electronic image storage system according to claim 135 or 136, wherein the user can select a building by clicking on (the fronts or tops of) them to either look through shop window or to “go in” the shop and look around the interior of the shop.

138. An electronic image storage system according to claim 135, wherein system is arranged to electronically receive images of shop fronts or shop interiors from shop owners or authorized persons.

139. An electronic image storage system according to any preceding claim, wherein system is arranged to display a plurality of images, in the way of a slideshow of successive individual photos

140. An electronic image storage system according any preceding claim, wherein system is arranged to display a plurality of images, in the way of multiple slideshows of individual photos, each slideshow showing photos taken in different directions.

141. An electronic image storage system according to any preceding claim, wherein system is arranged to display a plurality of images, in the way of a slideshow, and plurality of photos can be simultaneously displayed, e.g. consecutively one after the other, e.g. to provide a gapless panorama.

142. An electronic image storage system according to any preceding claim, wherein system comprises a map with address book data such as street numbers overlaying it, to assist user.

143. An electronic image storage system according to claim 65 or any preceding claim depending thereon, wherein location selection means comprises a path/route selection means allowing a user to choose at least two spaced locations and the image display means is arranged to display images of path/route.

144. An electronic image storage system according to claim 143, wherein the location selection means comprises a map interface means, and path selection means allows a user to select a path between two locations and image display means is arranged to display images corresponding to at least part of the selected path.

145. An electronic location image storage system according to claim 143 or 144, wherein the image display means is arranged to display a video corresponding to at least part of the selected path.

146. An electronic location image storage system according to claim 143 or 144, or 145, wherein the image display means is arranged to display photos corresponding to at least part of the selected path.

147. An electronic image storage system according to any of claims 143 to 146, wherein image display means is arranged to display images comprise one or more images of roadside landmarks, e.g. churches, pubs, or road related landmarks such as traffic lights, pelican crossings, along path.

148. An electronic image storage system according to any of claims 143 to 147, wherein the path selection means is arranged to allow a user to select at least part or a first road in combination with at least part of a second road.

149. An electronic image storage system according to any of claims 143 to 148, wherein the path selection means comprises a plurality of spaced points.

150. An electronic image storage system according to any of claims 143 to 148, wherein the path selection means comprises a plurality of selectable sections, each one spanning between two spaced locations.

151. An electronic image storage system according to any of claims 143 to 150, wherein the or each selectable location may comprise a polygon such as a square or circle to denote the location.

152. An electronic location image storage system according to any of claims 143 to 151, wherein the map interface means comprises selection highlighting means to highlight a location or section or path that has been selected.

153. An electronic location image storage system according to claim 152, wherein the selection highlighting means comprises means for colouring or shading a polygon denoting the selected location or the selected section.

154. An electronic image storage system according to any of claims 143 to 153, wherein the system comprises sequencing means to allow a user to sequence selected points or sections of path.

155. An electronic image storage system according to any of claims 143 to 154, wherein the selectable locations are visibly numbered for the user.

156. An electronic image storage system according to any of claims 143 to 155, wherein the image display means displays images of the points, sections, in a sequence corresponding to the sequence in which the points or sections were selected, e.g. as a sequential slideshow.

157. An electronic image storage system according to any of claims 143 to 156, wherein the electronic image displays system is arranged to display only images relating strictly to a selected path.

158. An electronic location image storage system according to preceding claim, wherein system comprises image slideshow or video relating to a location and means for allowing pause, fast forward, or rewind of the playback of a video or slideshow.

159. An electronic image storage system according to any preceding claim, wherein the system comprises map display means which can be displayed together with images displayed by the image display means.

160. An electronic location image storage system according to claim 156, wherein, as slideshow or video is played a cursor on map display means relating to location is moved.

161. An electronic location image storage system according to claim 156, wherein map display means allows movement of cursor by user and cursor movement causes corresponding change in slideshow or video.

162. An electronic image storage system according to any of claims 159 to 161, wherein the map display means is arranged so that, as the image changes from point to point or section to section etc. the point or section is highlighted to inform the user of the whereabouts of the image.

163. An electronic storage system according to any of claims 159 to 161, wherein system comprising a map and a still or moving image on a single split screen.

164. An electronic image storage and display system according to any preceding claim, wherein an image display means is arranged to display images at an angle transverse to the direction of the road.

165. An electronic image storage and display system according to any preceding claim, wherein an image display means is arranged to display images taken at an angle of less than 45 degrees to the plane of the ground.

166. An electronic image storage and display system according to any preceding claim, wherein an image display means is arranged to display images taken along a plane roughly parallel to the ground.

167. An electronic image storage and display system according to any preceding claim, wherein an image display means is arranged to display consecutive images taken at different angles to the road.

168. An electronic image storage and display system according to any preceding claim, wherein an image display means is arranged to display for each of a plurality of locations a plurality of photos at different angles to the direction of the road, e.g. at one location one image between 0 and 90 degrees to the left of the axis of the road, one image along the axis of the road, and one image at between 0 and 90 degrees to the right of the axis of the road.

169. An electronic image storage and display system according to any preceding claim, wherein system is arranged to allow a user to select one or more locations, and an image display means is arranged to displays a plurality of photos corresponding to the or each selected location.

170. An electronic image storage and display system according to any preceding claim, wherein an image display means is arranged to display at least one photo in a direction having an axis at an angle transverse to the axis of the road.

171. An electronic image storage and display system according to any preceding claim, wherein an image display means is arranged to display a photo taken in a direction having an axis between perpendicular and the direction along the road in the upstream direction.

172. An electronic image storage and display system according to any preceding claim, wherein an image display means is arranged to display a photo at an angle between forty five and minus forty five degrees to a horizontal plane.

173. An electronic image storage and display system according to any preceding claim, wherein an image display means is arranged to display at least one of the photos at an average angle of about twenty five and minus twenty five degrees to the plane.

174. An electronic image storage system according to any preceding claim, wherein the electronic location image storage system is internet-based.

175. An electronic image storage system according to any preceding claim, wherein System arranged to display distance of a selected path along with slideshow or video.

176. An electronic location image display system according to any of preceding claim, wherein the system is arranged so that a user can select one or more locations simply with a click of a mouse.

177. An electronic location image display system according to any preceding claim, wherein the system comprises video display means and an audio track on video arranged to impart geography related data.

178. An electronic location image display system according to any preceding claim, wherein audio track arranged to inform of house number in image, extent of the domicile or office in image, style of housing in image, for sale or sold prices/dates of house in image, dimensions of house in image, historical information pertaining to buildings in image, opening hours of shops in image, Or example of major/local dialect used at the location, local estate agents at location, or other information relating to the location, if and where a selected path includes tolls or narrow roads, if and where a selected path includes road gradients, if and where a selected path is prone to traffic jams, if and where a selected path has traffic lights etc., or if and where houses currently for sale on path.

179. An electronic location image display system according to claim 178, wherein system comprises means for providing written information akin to that in claim 178 relevant to location.

180. An electronic location image display system according any preceding claim, wherein image display means comprises image(s) taken through window or inside building, and when image(s) through window or inside building is displayed, information relating to products and services of building can be displayed, e.g. overlaying image or on audio track.

181. An electronic location image display system according claim 180, wherein information is price, size, colours, materials, source of goods, stock, or nearest real store, etc.

182. An electronic location image display system according to claim 181, wherein image of an item in a shop is shown, e.g. on rack, and user can click on icon to see item being modelled.

183. An electronic location image display system according to any preceding claim, wherein video display means is arranged to display for at least one selected location a video having images at different angles to the direction of the road, e.g. a video having some images which are in the direction of one side of the road and some images which are in the direction of the other side of the road.

184. An electronic location image display system according to any preceding claim, wherein Image display means comprises video display means and video playback runs at about average human walking speed in metres per second, preferably shows journey time on basis of that speed.

185. An electronic location image display system according to claim 184, wherein user can input a walking speed, e.g. fast, medium, slow, or their own walking speed, to recalculate time for them to walk along the complete path.

186. An electronic location image display system according to any preceding claim, wherein system arranged to display distance of selected path along with video.

187. An electronic image display system according to any preceding claim, wherein images are taken in a direction other than vertically downwardly.

188. An electronic image display system according to any preceding claim, wherein system stores locations of plural premises of a company name, system is arranged to receive a user entered postcode, zip code, address, or place name, and display means is arranged to display plurality of images, e.g. images of vicinity of building, or images of a route to or from, of the nearest premises from free or paid for car parking or public transport, e.g. train station.

189. An electronic image storage system substantially as described herein with reference to one or more of the accompanying drawings.

190. An image recording apparatus for recording an image of a location, the apparatus comprising a global positioning system, transmission means for transmitting an image, and its GPS location, to a storage means, characterized in that the apparatus has a compass to measure the North, South, East, West direction in which image is recorded or the like.

191. An image recording apparatus according to claim 190, wherein the GPS is arranged to notify a person such as a vehicle occupant to record images, other means of notifying occupant to record images at predetermined intervals, e.g. vehicle odometer, or system is arranged to automatically record images.

192. An image recording apparatus according to claim 190 or 191, wherein image recording system is arranged in or on a vehicle.

193. A method of constructing a database of images, the method comprising mounting an electronic image recording apparatus for recording (photo or video) images of a plurality of locations on a vehicle, moving the vehicle incrementally, recording an elevation image of a location at each step.

194. A method of constructing a database of images according to claim 193, wherein method comprises arranging image recording apparatus to record images in a direction transverse to the direction of the road.

195. A method of constructing a database of images according to claim 193 or 194, wherein the step of moving the vehicle incrementally comprises moving between 1 m and 200 m, preferably every 10-50 m.

196. A method of constructing a database of images according to claim 193, 194 or 195, wherein the of moving the vehicle incrementally comprises moving vehicle optimum amount along path so as to minimize overlap of images and avoid missing detail along path.

197. A method of constructing a database of images according to claim 193 to 196, wherein the method comprises recording a plurality of images at each location, e.g. in different direction or at different focal lengths.

198. A method of constructing a database of images according to claim 193 to 197, wherein method comprises storing image of each location.

199. A method of constructing a database of images according to claim 193 to 198, wherein method comprises storing GPS location of each image.

200. A method of constructing a database of images according to claim 193 to 199, wherein the method comprises transmitting the or each image, and its GPS location, to a remote storage means.

201. A method of constructing a database of images according to claim 200, wherein the method comprises transmitting date and/or time of recording image to storage means.

202. A method of constructing a database of images according to claim 200 or 201, wherein the method comprises transmitting the image with a direction in which the photo was taken.

203. A method of constructing a database of images according to any of claims 200 to 202, wherein the method comprises storing gps location of image in a manner such that gps location of image can be reviewed without opening image, e.g. so image location can quickly be checked before entry to an appropriate place in a database.

204. A method of constructing a database of images according to any of claims 200 to 203, wherein the method comprises submitting an image onto a map interface means, preferably submitting a plurality of images onto a map interface means.

205. A method of constructing a database of images according to claim 204, wherein the method comprises overwriting map interface means with GPS locations, e.g. to assist user in placing images thereon.

206. An image recording assembly comprising two image recording devices arranged to face in different directions so that each of the two image recording devices can record different images.

207. An image recording assembly according to claim 206, wherein the image recording devices are arranged at 90 degrees from one another, e.g. so that the first image recording device can record images in the direction up or down the road and the second image recording device can record images in the direction of a side of road.

208. An image recording assembly according to claim 206, wherein the image recording devices are arranged at 180 degrees to face opposite directions, e.g. so that the first image recording device can record images of one side of the road and the second image recording device can record images of the other side of the road.

209. An image recording assembly according to claim 208, wherein the image recording assembly comprises a third image recording device, and the third image recording devices is arranged at 90 degrees from first and third so that each of the three image recording devices can record different images.

210. An image recording assembly according to claim 209, wherein the image recording assembly comprises a fourth image recording device, and the fourth image recording devices is arranged at 90 degrees from first and third and 180 degrees from second, so that each of the four image recording devices can record different images.

211. An image recording assembly according to any of claims 206 to 210, wherein the image recording assembly is mounted on a movable object such as a vehicle or robot.

212. An image recording assembly according to any of claims 206 to 211, wherein the image recording assembly comprises a distance measuring device such as an odometer and system is arranged to take images either at preset intervals or alert vehicle occupant to take an image.

213. An image recording assembly according to claim 212, wherein the assembly comprises means for measuring real distance spanned by an image and assembly can take photos at intervals approximately equal to span of image or alert vehicle occupant to take an image.

214. An image recording assembly according to any of claims 206 to 211, wherein the image recording assembly comprises a GPS sensor and one or more of the devices is arranged to take images at preset GPS locations or alert vehicle occupant to take an image.

215. An image recording assembly according to any of claims 206 to 211, wherein the image recording assembly is arranged to take images either at preset time intervals or alert vehicle occupant to take an image at certain location.

216. An image recording assembly according to any of claims 206 to 214, wherein the image recording assembly is voice operated.

217. An image recording assembly according to any of claims 206 to 214, wherein the image recording assembly is remotely operated.

218. An image recording assembly according to any of claims 206 to 214 or 216, wherein the image recording assembly is wirelessly operated.

219. An image recording assembly according to any of claims 206 to 217, wherein the image recording assembly is arranged to take simultaneous recording of images.

220. An image recording assembly according to any of claims 206 to 218, wherein the recording devices are connected to separate memories.

221. An image recording assembly according to any of claims 206 to 218, wherein the assembly has a compass and can save direction in which image was taken along with image.

222. An image recording assembly comprising a screen arranged to display the extent of last recorded still image of a side of a road, and screen also being arranged to display a moving image of a side of a road corresponding to the image seen through the viewfinder.

223. An image recording assembly according to any of claims 206 to 222, wherein a screen does the same for another side of the road.

224. An image recording assembly according to any of claims 206 to 223, wherein the image recording device has storage means and GPS which triggers display of existing image(s) held for the location in storage means, allowing user to survey a location to check if there has been a change in appearance of the location.

225. An image recording assembly according to claim 224, wherein the image recording device has two (adjacent) screens allowing new image of the location and the old to be compared, on screens.

226. An electronic location image recording apparatus such as a mobile phone having an integrated or associated GPS receiver and an integrated or associated camera, the mobile phone being arranged to record an image, e.g. a photograph, of a location and (wirelessly) transmit the image of the location to a electronic database, the mobile phone also being arranged to transmit the location, e.g. in GPS form, at which location the photo was taken.

227. An electronic location image recording apparatus according to claim 226, wherein apparatus is arranged to record images, e.g. a photograph, of a plurality of locations and transmit images of the locations, and to transmit the locations, e.g. in GPS form, or by text or by phone, at which location the photo or video was taken.

228. An electronic location image recording apparatus according to claim 226 or 227, wherein apparatus has a compass or the like and so is able to transmit direction in which the photo or video was taken.

229. An electronic location image storage system, comprising an apparatus according to claim 226 or 227 or 228, and a central electronic database arranged to receive images from apparatus.

230. An electronic location image storage system according to claim 229, wherein photo or video is electronically stored in an approval bay.

231. An electronic location image storage system according to claim 230, wherein system comprises a second storage means which can receive the image after quality verification.

232. An electronic location image storage system according to any of claims 229 to 231, wherein system comprises means for sending user an electronic reward such as a password for access to a website or e.g. by being able to view images up to a certain memory for free or nominal amount.

233. An electronic location image storage system according to any of claims 229 to 232, and mobile phone is arranged to transmit a location at which an image is obtained to a first storage means, the mobile phone also being arranged to transmit an image of the location to a second storage means.

234. An electronic location image storage system according to any of claims 229 to 233, wherein system is arranged to upload certain images from users straight onto a database of images to be viewed by the public, e.g. images of non-urban locations, or images from users who have good rating on previously submitted images.

235. An electronic location image storage system according to any preceding claim, wherein system can become portable by storing images on laptop, P.D.A., or mobile phone memory or the like, for subsequent use.

236. An electronic location image storage system according to claim 235, wherein laptop, P.D.A., or mobile phone memory or the like has an index of roads, sections of roads, points along roads, etc. and corresponding images, so user can view specific roads, sections of roads, points along roads, etc.

237. An electronic location image storage system according to claim 236, wherein laptop, P.D.A., or mobile phone memory or the like has index of urban areas such as towns, cities.

238. An electronic location image storage system according to any preceding claim, wherein system has security measures which restricts number of images which can be downloaded by a user.

239. An electronic location image storage system according to claim 238, wherein system allow images of a predetermined maximum number of roads, predetermined total road length, or predetermined amount of memory to be downloaded.

240. A phone or computer having an image storage and display system, storage means storing a plurality of images, wherein the storage means comprising a plurality of images taken in a direction transverse to an axis of a road so as to show part of a side of a road, the system comprises a location selection interface arranged to allow a user to select a location, and the system is arranged to receive and process selection, and retrieve an image of a selected location from storage means.

241. A phone or computer according to claim 240, wherein phone or computer comprises suitable software to carry out functions.

242. A computer program (e.g. on a carrier) which is arranged to read from an image the location at which image was obtained and the side of the road to which image relates, and means for storing the image at the appropriate location and side of the road on a map interface.

243. Satellite navigation equipment, such as in car satellite navigation equipment, comprising an image storage and display system according to any preceding claim.

244. Satellite navigation equipment according to claim 243, wherein equipment arranged so that a route can be chosen, and the system is arranged to retrieve and display one or more images of landmarks along the route.

245. Satellite navigation equipment according to claim 244, wherein equipment arranged so that images can be accompanied by instructions relating to a particular landmark, e.g. “turn left after the Church on your left”.

246. Satellite navigation equipment according to any of claims 243 to 245, wherein equipment arranged so that a user can touch the screen of satellite navigation equipment satellite navigation equipment so that an image is displayed of the location at which the satellite navigation cursor is positioned the time of contact

247. Satellite navigation equipment according to any of claims 243 to 245, wherein equipment arranged so that voice command satellite navigation equipment so that an image is displayed of the location at which the satellite navigation cursor is positioned at the time of the command.

248. Satellite navigation equipment according to claim 246 or 247, wherein equipment arranged so that position of cursor on map can remain visible whilst image displayed.

249. Satellite navigation equipment according to any of claims 243 to 248, wherein equipment arranged so that a user can enter a route and satellite navigation equipment can give image(s) of place at which you turn into final road to get to the destination,

250. Satellite navigation equipment according to any of claims 243 to 249, wherein equipment arranged so that a user can enter a route and satellite navigation equipment can give image(s) of place at which you turn into a penultimate road, a place at which you turn into second last road, etc.

251. Satellite navigation equipment according to any of claims 243 to 249, wherein equipment arranged so that a user can enter a route and as vehicle moves along route, user can simply request satellite navigation equipment “show me the next turn”, wherein image of roadside is shown at place where turn should be taken.

252. An Internet based road navigation system comprising input means for a user to input a route between a first location and a second location, output means for displaying a map of the route between the first location and the second location and/or a list of instructions, the system also having means for retrieving an image from a database relating to one or more roads on the route, and means for displaying the image or images.
